(19) United States
(12) Patent Application Publication
(10) Pub. No.: US 2025/0239419 A1
(43) Pub. Date: Jul. 24, 2025

(54) ONE-STEP SYNTHESIS OF BARIUM OXIDE-CERIUM OXIDE THIN FILM ELECTRODES FOR HIGH-PERFORMANCE ASYMMETRIC SUPERCAPACITORS

(71) Applicant: PRINCESS NOURAH BINT ABDULRAHMAN UNIVERSITY, Riyadh (SA)

(72) Inventors: Rushikesh G. BOBADE, Khopoli (IN); Thamraa ALSHAHRANI, Riyadh (SA); Bidhan PANDIT, London (GB); Revanappa C. AMBARE, Khopoli (IN); Anuj KUMAR, Mathura (IN); Mohd UBAIDULLAH, Riyadh (SA); Abdullah M. AL-ENIZI, Riyadh (SA); V Jagadeesha ANGADI, Hubballi (IN); Mohd. SHKIR, Abha (SA); Yufeng ZHO, Shanghai (CN)

(73) Assignee: PRINCESS NOURAH BINT ABDULRAHMAN UNIVERSITY, Riyadh (SA)

(21) Appl. No.: 19/172,137

(22) Filed: Apr. 7, 2025

(51) Int. Cl. H01G 11/86; C01B 32/354; C01F 17/32; H01G 11/34

(52) U.S. Cl. CPC H01G 11/86; C01B 32/354; C01F 17/32; H01G 11/34; C01P 2002/72; C01P 2002/85; C01P 2004/03; C01P 2004/04; C01P 2004/61; C01P 2006/12; C01P 2006/40

(57) ABSTRACT

The present invention generally relates to a process of fabricating an asymmetric supercapacitors device comprising synthesizing a BaO and CeO₂ thin film as a first electrode using a one-step successive ionic layer adsorption and reaction (SILAR) method for uniform deposition and adhesion on a conductive substrate; synthesizing an activated carbon (AC) electrode as a second electrode; formulating a solid-state electrolyte layer comprising polyvinyl alcohol (PVA) and potassium hydroxide (KOH), wherein the solid-state electrolyte layer is formed as a gel; assembling the device by layering the first electrode, the solid-state electrolyte layer, and the second electrode in a stacked configuration, wherein the assembled device is allowed to stabilize for a period of 12-24 hours at room temperature to ensure uniform distribution of the electrolyte and structural integrity; and pressing the assembled layers together to enhance contact between electrodes and the electrolyte.

### TECHNICAL FIELD

The present disclosure relates to the field of energy storage devices, specifically to the design and fabrication of high-performance asymmetric supercapacitors. More particularly, the invention pertains to a one-step synthesis process for producing barium oxide-cerium oxide (BaO-CeO₂) thin film electrodes, which serve as the positive electrode in asymmetric supercapacitor device. The invention emphasizes the development of efficient, scalable, and cost-effective electrode fabrication techniques to enhance the electrochemical performance, energy density, and durability of supercapacitor devices for advanced energy storage applications.

### BACKGROUND

In the contemporary landscape of energy storage applications, the study as well development of supercapacitors is of paramount importance due to their unique capabilities in bridging a performance gap among conventional capacitors as well batteries. Supercapacitors, also known as electrochemical capacitors, offer rapid charge and discharge rates, extensive cycle life, and superior power density, construction them ideal for applications that need rapid bursts of energy. The demand for efficient energy storage systems continues to rise, particularly in renewable energy integration, electric vehicles, and portable electronics, advancements in supercapacitor technology have become essential. The ongoing pursuit of innovative materials and fabrication techniques is crucial to enhancing energy density while maintaining high performance, leading to the exploration of more composite materials such as barium oxide (BaO) and cerium oxide (CeO₂) for improved supercapacitor applications.

Barium oxide have garnered noteworthy attention in energy storage research because of its excellent electrical conductivity and electrochemical stability. Its incorporation into supercapacitor electrodes can significantly enhance charge storage capabilities and overall device performance. Similarly, cerium oxide is well-known for its unique redox properties and high surface area, which facilitate improved ion transport and charge storage. The combination of these two oxides in a composite thin film electrode can lead to synergistic effects that enhance an electrochemical belonging of the device. By leveraging a strength of both BaO as well CeO₂, researchers can potentially create an electrode material that not only achieves high specific capacitance (Cs) but also sustains structural integrity and operational stability over extended cycles.

The synthesis of barium oxide-cerium oxide (BaO//CeO₂) composite thin film electrodes using a one-step Successive Ionic Layer Adsorption and Reaction (SILAR) technique presents several advantages in a context of supercapacitor technology. This approach allows for particular control over a film thickness as well composition, resulting in uniform and consistent electrode materials. The one-step synthesis process significantly reduces production time and complexity compared to traditional multi-step methods, making it a more efficient and scalable option for large-scale manufacturing. The composite structure can promote enhanced electrochemical interactions between two materials, leading to better-quality energy as well power density in supercapacitor devices.

The integration of BaO and CeO₂ into a single composite electrode not only offers improvements in performance but also addresses the growing need for sustainable as well cost-effective energy storing solutions. As a world shifts toward greener energy systems, the development of progressive materials that utilize abundant as well environmentally friendly precursors is vital. The BaO//CeO₂ composite thin film electrodes demonstrate the potential to deliver high-performance energy storage while contributing to sustainable practices. By enhancing the electrochemical properties of supercapacitors through innovative materials and synthesis techniques, this invention aligns with global energy trends and supports the advancement of efficient, high-performance supercapacitor devices appropriate for a extensive range of applications.

The advancement of energy storage technologies has driven extensive research into supercapacitors, particularly asymmetric supercapacitors, because of their higher power density, quick charging or discharging capabilities, as well long cycle life. Historically, various materials has been discovered for supercapacitor electrodes, counting carbon-based materials, transition metal oxides, as well conducting polymers. Among these, transition metal oxides such as barium oxide (BaO) and cerium oxide (CeO₂) have emerged as promising candidates due to their favorable electrochemical properties, including high specific capacitance, enhanced electrical conductivity, and good stability under electrochemical cycling. Previous studies have demonstrated that BaO exhibits significant capacitance when employed as an electrode material, primarily attributed to its layered structure, which facilitates ion insertion and diffusion. Likewise, CeO₂ has garnered attention for its unique redox properties, allowing for enhanced charge storage capabilities through reversible oxidation-reduction reactions.

The synthesis methods for these oxides have evolved over time, with various techniques such as sol-gel, co-precipitation, and chemical vapor deposition being commonly utilized. However, these methods often involve multi-step processes that can be time-consuming and costly, potentially hindering the scalability and practical application of the resulting materials. The SILAR method presents a viable alternative, offering a simple, cost-effective, as well environmentally friendly approach for synthesizing metal oxide thin films. This technique allows for particular control over film thickness as well composition, enabling a formation of high-quality BaO and CeO₂ thin films in a single-step process. As research progresses, the integration of BaO and CeO₂ through the SILAR method has the potential to produce composite electrodes that capitalize on the individual strengths of each oxide, ultimately enhancing the performance of asymmetric supercapacitors. Such advancements highlight the need for innovative synthesis approaches that facilitate a development of efficient energy storing devices, underscoring the relevance of this patent in the current landscape of energy technologies.

In view of the foregoing discussion, it is portrayed that there is a need to have a process of fabricating an asymmetric supercapacitors device and an asymmetric supercapacitors device.

### BRIEF SUMMARY

The present disclosure seeks to provide a SILAR synthesis technique for producing high-performance barium oxide-cerium oxide (BaO//CeO₂) thin film electrodes specifically tailored for asymmetric supercapacitors. The innovative synthesis process combines the benefits of both BaO and CeO₂, yielding a composite electrode that enhances energy storage efficiency, power density, and cycling stability. By employing the SILAR technique, this method achieves precise control over film thickness and composition in a single-step process, significantly reducing time, cost, and complexity compared to traditional multi-step synthesis approaches. The resulting BaO//CeO₂ thin film electrode demonstrates improved electrochemical performance, production it a robust solution for advanced supercapacitor device in energy storage. This patent outlines the process, benefits, and unique capabilities of this electrode fabrication method, underscoring its potential to transform the development of efficient, scalable energy storage devices.

In an embodiment, a process of fabricating an asymmetric supercapacitors device is disclosed. The process includes synthesizing a BaO and CeO₂ thin film as a first electrode using a one-step successive ionic layer adsorption and reaction (SILAR) method for uniform deposition and adhesion on a conductive substrate.

The process further includes synthesizing an activated carbon (AC) electrode as a second electrode.

The process further includes formulating a solid-state electrolyte layer comprising polyvinyl alcohol (PVA) and potassium hydroxide (KOH), wherein the solid-state electrolyte layer is formed as a gel.

The process further includes assembling the device by layering the first electrode, the solid-state electrolyte layer, and the second electrode in a stacked configuration, wherein the assembled device is allowed to stabilize for a period of 12-24 hours at room temperature to ensure uniform distribution of the electrolyte and structural integrity.

The process further includes pressing the assembled layers together to enhance contact between electrodes and the electrolyte.

In another embodiment, the SILAR process for synthesizing BaO and CeO₂ thin films includes multiple cycles of ion adsorption and reaction, followed by rinsing and annealing to enhance material uniformity and adhesion, wherein the pressing step is performed under a specific pressure range to ensure optimal contact between the layers without damaging the electrodes or electrolyte, wherein the first electrode is a positive electrode, wherein the second electrode is a negative electrode.

According to one embodiment, the preparation of the PVA-KOH gel electrolyte involves dissolving polyvinyl alcohol in water, mixing it with a potassium hydroxide solution, and allowing the mixture to form a gel under controlled temperature conditions.

In a further embodiment, the barium oxide-cerium oxide (BaO//CeO₂) composite thin films synthesis, comprising preparing a first solution as a mixed precursor solution comprising 50% of 0.5 M barium nitrate (Ba (NO₃)₂), and 50% of 0.5 M cerium nitrate (Ce(NO₃)₃·6H₂O). Then, preparing additional solutions, including a second solution comprising distilled water, a third solution comprising 1 M sodium hydroxide (NaOH), and a fourth solution comprising distilled water. Then, sequentially dipping a substrate into the prepared solutions, including immersing the substrate in the mixed precursor solution to adsorb barium and cerium ions onto the substrate surface, rinsing the substrate in the second solution to remove excess ions, immersing the substrate in the third solution to facilitate the formation of a barium-cerium hydroxide composite film, and rinsing the substrate in the fourth solution. Then, repeating the sequential dipping process for 80 cycles, with each dipping step lasting 60 seconds and each rinsing step lasting 20 seconds, to achieve a desired film thickness and uniformity. Thereafter, drying the coated substrate at an elevated temperature of 573 K for 1 hour to ensure crystallization and structural stability, yielding BaO//CeO₂ composite thin films.

In a particular embodiment, the solid-state electrolyte formulation, comprising dissolving 3-4 grams of polyvinyl alcohol (PVA) in 40-50 milliliters of deionized water (DW) to form a solution. Then, heating the solution to a temperature of about 348-353 K under stirring to form a gel; cooling the gel to ambient temperature. Then, adding a 10-15 milliliters of 1 M potassium hydroxide (KOH) solution to the cooled gel. Thereafter, mixing the gel and KOH solution for a period of about 6-7 hours to ensure complete incorporation of KOH into the gel.

The process further comprises transferring the gel to a Petri dish and allowing the gel to dry naturally at room temperature to form a flexible and uniform solid-state electrolyte layer.

According to a specific embodiment, the activated carbon (AC) electrode synthesis, comprising dissolving 1 gram of polyvinyl alcohol (PVA) in 10-15 milliliters of distilled water to form a solution. Then, heating the solution to a temperature of about 343-353 K under stirring for 2-3 hours to form a PVA solution. Then, adding activated carbon (AC) to the PVA solution. Then, stirring the mixture of PVA and AC for a period of about 2 hours at a temperature of about 343-353 K to form a uniform slurry. Then, placing the resulting PVA-AC slurry in a desiccator for drying. Then, applying the slurry to a substrate. Thereafter, drying the slurry on the substrate for formation of the AC electrode layer.

In some embodiments, applying the slurry to the substrate comprises using a doctor blade to form a thin and consistent film, wherein the drying step comprises drying the slurry at ambient temperature for about 4 hours followed by heat treatment.

The process further comprising heat treating the coated substrate in a muffle furnace at a temperature of about 353 K for a period of about 6-7 hours.

In a further embodiment, an asymmetric supercapacitors device is disclosed. The device includes a conductive substrate selected from a group of stainless steel, glassy carbon, or fluorine-doped tin oxide (FTO).

The device further includes a first electrode comprising a thin film of BaO and CeO₂ disposed on the conductive substrate.

The device further includes a second electrode comprising activated carbon (AC).

The device further includes a solid-state electrolyte layer disposed between the first and second electrodes, the electrolyte layer comprising polyvinyl alcohol (PVA) and potassium hydroxide (KOH) to facilitate ion transport and electrically isolate the electrodes to prevent short circuits, wherein the solid-state electrolyte layer is a gel electrolyte.

The device further includes a current collector in contact with each of the first and second electrodes, wherein said first electrode is a positive electrode and said second electrode is a negative electrode.

An object of the present disclosure is to provide a novel and efficient process for synthesizing barium oxide-cerium oxide (BaO//CeO₂) thin film electrodes using the Successive Ionic Layer Adsorption and Reaction (SILAR) technique.

Another object of the present disclosure is to achieve precise control over film thickness and composition in a single-step synthesis process, thereby reducing the time, cost, and complexity associated with traditional multi-step fabrication methods.

A further object of the present disclosure is to combine the complementary electrochemical properties of BaO and CeO₂ to produce a composite electrode with superior performance for energy storage applications.

Another object of the present disclosure is to provide a scalable and reproducible electrode fabrication process suitable for large-scale production of advanced energy storage devices.

Another object of the present disclosure is to enhance the electrochemical performance of asymmetric supercapacitors by leveraging the unique capabilities of the BaO//CeO₂ composite electrode, including improved capacitance, reduced internal resistance, and prolonged cycling stability.

Another object of the present disclosure is to offer an innovative solution for the development of robust and durable energy storage devices capable of meeting the growing demands for high-performance, cost-effective, and sustainable energy systems.

Another object of the present disclosure is to outline the process and benefits of using the SILAR technique for fabricating thin film electrodes, emphasizing its potential to transform the field of energy storage technology.

Yet another object of the present invention is to deliver an expeditious and cost-effective high-performance BaO//CeO₂ thin film electrodes specifically tailored for asymmetric supercapacitors, offering enhanced energy storage efficiency, power density, and cycling stability.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of an asymmetric supercapacitors device in accordance with an embodiment of the present disclosure;

FIG. 2 illustrates a flow chart of a process of fabricating an asymmetric supercapacitors device in accordance with an embodiment of the present disclosure;

FIG. 3 illustrates a X-ray diffraction (XRD) patterns of the synthesized BaO, CeO₂, and BaO//CeO₂ thin film;

FIG. 4(a) illustrates a FE-SEM images at 1 μm of BaO//CeO₂;

FIG. 4(b) illustrates a FE-SEM images at 1 μm of BaO;

FIG. 4(c) illustrates a FE-SEM images at 1 μm of CeO₂;

FIG. 4(d) illustrates elemental mapping images of BaO//CeO₂ thin film;

FIG. 4(e) illustrates elemental mapping images of O;

FIG. 4(f) illustrates elemental mapping images of BaO;

FIG. 4(g) illustrates elemental mapping images of Ce;

FIG. 4(h) illustrates TEM image of BaO//CeO₂ thin film;

FIG. 5(a) illustrates Survey spectrum of BaO//CeO₂ thin film, showing key peaks corresponding to cerium (Ce 3 d), barium (Ba 3 d), oxygen (O 1 s), and carbon (C 1 s);

FIG. 5(b) illustrates deconvoluted XPS spectrum of Ce 3 d;

FIG. 5(c) illustrates deconvoluted XPS spectrum of Ba 3 d;

FIG. 5(d) illustrates deconvoluted XPS spectrum of O 1 s;

FIG. 6(a) illustrates cyclic voltammetry (CV) curves of a BaO, CeO₂, and BaO//CeO₂ electrode at sweep rate of 5 mV/s;

FIG. 6(b) illustrates plot of specific capacitance in F/g versus sweep rate in mV/s of BaO, CeO₂, and BaO//CeO₂ electrode respectively;

FIG. 6(c) illustrates Cyclic voltammetry plots of the BaO//CeO₂ electrode at dissimilar sweep rates from 5-100 mV/s;

FIG. 6(d) plot of specific capacitance in F/g versus dissimilar sweep rates form 5-100 mV/s respectively of BaO//CeO₂ electrode;

FIG. 7(a) illustrates Galvanostatic charge-discharge (GCD) plots of the BaO//CeO₂ electrode at current densities ranging of 3-7 A/g, illustrating the charge-discharge behaviour;

FIG. 7(b) illustrates regon plot of energy density (SE) in Wh/kg versus power density (SP) in W/kg of BaO//CeO₂ electrode;

FIG. 7(c) illustrates cycling stability plot, indicating 75.8% capacitance holding after 6500 cycles for the BaO//CeO₂ electrode, demonstrating excellent long-term electrochemical stability;

FIG. 7(d) illustrates Nyquist plot of the BaO//CeO₂ electrode, showing the internal resistance (Ri) of 1 Ω, representing low resistive losses, inside an equivalent circuit model used to fit an experimental electrochemical impedance spectroscopy (EIS) data;

FIG. 8(a) illustrates The CV plots of the asymmetric supercapacitor at varying sweep rates of 5 to 100 mV/s, showing a device electrochemical behavior at dissimilar sweep rates;

FIG. 8(b) illustrates plot of Cs in F/g versus sweep rate of BaO//CeO_{2∥}1M PVA-KOH_{∥}AC asymmetric supercapacitor device (ASSD) device;

FIG. 8(c) illustrates the GCD plots of the ASSD device at current densities ranging of 2-6 A/g, illustrating the charge-discharge behaviour;

FIG. 8(d) illustrates regon plot of SE in Wh/kg versus SP in W/kg of ASSD device; and

FIG. 8(e) illustrates cyclic stability test of the BaO//CeO_{2∥}1M PVA-KOH_{∥}AC asymmetric supercapacitor, measured at constant current density.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION:

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

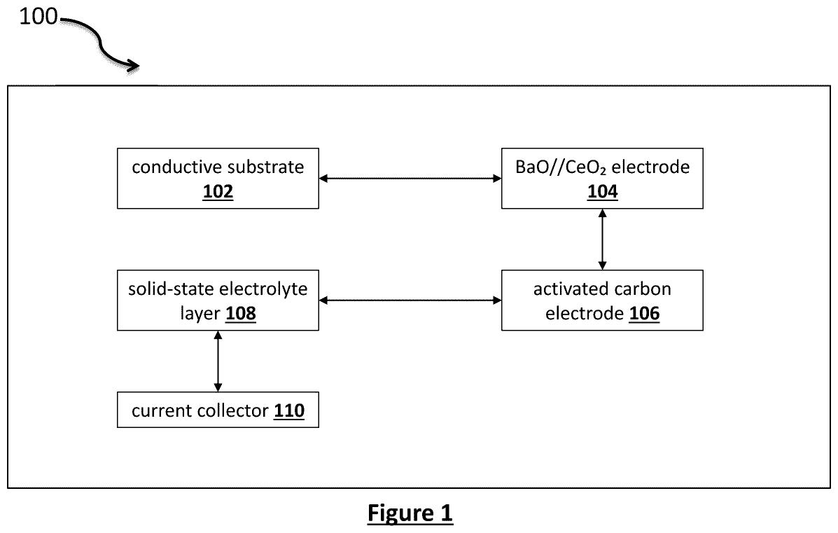

Referring to FIG. 1, a block diagram of an asymmetric supercapacitors device is illustrated in accordance with an embodiment of the present disclosure. The device (100) includes a conductive substrate (102) is selected from a group of stainless steel, glassy carbon, or fluorine-doped tin oxide (FTO).

In an embodiment, a first electrode (104) comprising a thin film of BaO and CeO₂ disposed on the conductive substrate (102).

In an embodiment, a second electrode (106) comprising activated carbon (AC).

In an embodiment, a solid-state electrolyte layer (108) is disposed between the first and second electrodes, the electrolyte layer comprising polyvinyl alcohol (PVA) and potassium hydroxide (KOH) to facilitate ion transport and electrically isolate the electrodes to prevent short circuits, wherein the solid-state electrolyte layer (108) is a gel electrolyte.

In an embodiment, a current collector (110) is in contact with each of the first and second electrodes, wherein said first electrode is a positive electrode and said second electrode is a negative electrode.

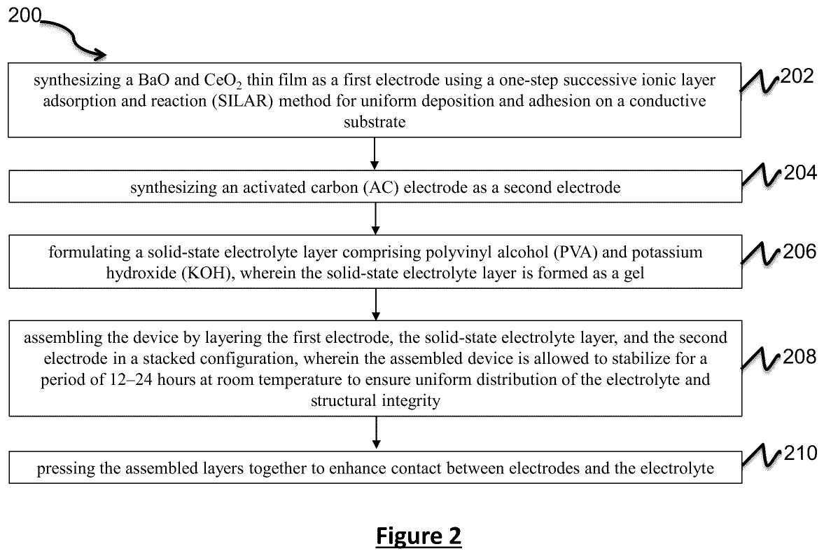

FIG. 2 illustrates a flow chart of a process of fabricating an asymmetric supercapacitors device in accordance with an embodiment of the present disclosure.

At step (102), process (100) includes synthesizing a BaO and CeO₂ thin film as a first electrode using a one-step successive ionic layer adsorption and reaction (SILAR) method for uniform deposition and adhesion on a conductive substrate.

At step (104), process (100) includes synthesizing an activated carbon (AC) electrode as a second electrode.

At step (106), process (100) includes formulating a solid-state electrolyte layer comprising polyvinyl alcohol (PVA) and potassium hydroxide (KOH), wherein the solid-state electrolyte layer is formed as a gel.

At step (108), process (100) includes assembling the device by layering the first electrode, the solid-state electrolyte layer, and the second electrode in a stacked configuration, wherein the assembled device is allowed to stabilize for a period of 12-24 hours at room temperature to ensure uniform distribution of the electrolyte and structural integrity.

At step (110), process (100) includes pressing the assembled layers together to enhance contact between electrodes and the electrolyte.

In another embodiment, the SILAR process for synthesizing BaO and CeO₂ thin films includes multiple cycles of ion adsorption and reaction, followed by rinsing and annealing to enhance material uniformity and adhesion, wherein the pressing step is performed under a specific pressure range to ensure optimal contact between the layers without damaging the electrodes or electrolyte, wherein the first electrode is a positive electrode, wherein the second electrode is a negative electrode.

According to one embodiment, the preparation of the PVA-KOH gel electrolyte involves dissolving polyvinyl alcohol in water, mixing it with a potassium hydroxide solution, and allowing the mixture to form a gel under controlled temperature conditions.

In a further embodiment, the barium oxide-cerium oxide (BaO//CeO₂) composite thin films synthesis, comprising preparing a first solution as a mixed precursor solution comprising 50% of 0.5 M barium nitrate (Ba(NO₃)₂), and 50% of 0.5 M cerium nitrate (Ce(NO₃)₃·6H₂O). Then, preparing additional solutions, including a second solution comprising distilled water, a third solution comprising 1 M sodium hydroxide (NaOH), and a fourth solution comprising distilled water. Then, sequentially dipping a substrate into the prepared solutions, including immersing the substrate in the mixed precursor solution to adsorb barium and cerium ions onto the substrate surface, rinsing the substrate in the second solution to remove excess ions, immersing the substrate in the third solution to facilitate the formation of a barium-cerium hydroxide composite film, and rinsing the substrate in the fourth solution. Then, repeating the sequential dipping process for 80 cycles, with each dipping step lasting 60 seconds and each rinsing step lasting 20 seconds, to achieve a desired film thickness and uniformity. Thereafter, drying the coated substrate at an elevated temperature of 573 K for 1 hour to ensure crystallization and structural stability, yielding BaO//CeO₂ composite thin films.

In a particular embodiment, the solid-state electrolyte formulation, comprising dissolving 3-4 grams of polyvinyl alcohol (PVA) in 40-50 milliliters of deionized water (DW) to form a solution. Then, heating the solution to a temperature of about 348-353 K under stirring to form a gel; cooling the gel to ambient temperature. Then, adding a 10-15 milliliters of 1 M potassium hydroxide (KOH) solution to the cooled gel. Thereafter, mixing the gel and KOH solution for a period of about 6-7 hours to ensure complete incorporation of KOH into the gel.

The process further comprises transferring the gel to a Petri dish and allowing the gel to dry naturally at room temperature to form a flexible and uniform solid-state electrolyte layer.

According to a specific embodiment, the activated carbon (AC) electrode synthesis, comprising dissolving 1 gram of polyvinyl alcohol (PVA) in 10-15 milliliters of distilled water to form a solution. Then, heating the solution to a temperature of about 343-353 K under stirring for 2-3 hours to form a PVA solution. Then, adding activated carbon (AC) to the PVA solution. Then, stirring the mixture of PVA and AC for a period of about 2 hours at a temperature of about 343-353 K to form a uniform slurry. Then, placing the resulting PVA-AC slurry in a desiccator for drying. Then, applying the slurry to a substrate. Thereafter, drying the slurry on the substrate for formation of the AC electrode layer.

In some embodiments, applying the slurry to the substrate comprises using a doctor blade to form a thin and consistent film, wherein the drying step comprises drying the slurry at ambient temperature for about 4 hours followed by heat treatment.

The process further comprising heat treating the coated substrate in a muffle furnace at a temperature of about 353 K for a period of about 6-7 hours.

In an embodiment, each of the 80 cycles of the successive ionic layer adsorption and reaction includes a precise substrate immersion protocol, wherein the substrate is initially held vertically in the barium nitrate and cerium nitrate mixed precursor solution for 60 seconds with no agitation, followed by manual angular tilting of the substrate at 30° increments in a clockwise rotation during each 10-second interval within the 60-second duration to facilitate directional ion anchoring across the surface topology, wherein the subsequent immersion in distilled water involves lateral oscillation of the substrate at a fixed amplitude of 5 mm and frequency of 2 Hz during the entire 20-second rinse to dislodge uncoordinated ions, wherein immersion into 1 M sodium hydroxide is conducted with real-time monitoring of pH at the substrate surface using a micro-electrode, and wherein a final rinse in distilled water is immediately performed under laminar flow conditions to prevent ion redistribution, and wherein each cycle is separated by a 10-second ambient exposure period with the substrate held in a dust-free acrylic enclosure to maintain reproducibility of surface hydration conditions across successive cycles.
In one embodiment, the process of successive ionic layer adsorption and reaction (SILAR) for the fabrication of BaO//CeO₂ thin films is executed through a meticulously structured cycle, repeated 80 times, to ensure uniform and stoichiometrically balanced deposition of the composite oxide layers. Each cycle initiates with the substrate being vertically immersed in a mixed precursor solution of barium nitrate and cerium nitrate for a fixed period of 60 seconds. During the initial phase of this immersion, no agitation is introduced, allowing for the unhindered diffusion of precursor ions onto the substrate's surface. After the first 10 seconds, the substrate is subjected to a controlled manual angular tilting sequence in a clockwise direction, rotating the substrate by 30° every 10 seconds. This dynamic manipulation not only enhances ion contact with varied surface planes but also promotes directional ion anchoring along nanoscale morphological features, significantly improving layer uniformity and adhesion.
Following this precursor immersion, the substrate is immediately transferred to a distilled water bath for rinsing, where it undergoes lateral oscillations with a consistent amplitude of 5 mm and a frequency of 2 Hz for 20 seconds. This movement effectively dislodges loosely bound and uncoordinated ions from the surface without disrupting the chemically bonded layer, ensuring that only stable ionic interactions persist. Subsequently, the substrate is immersed in a 1 M sodium hydroxide solution, which acts as a reaction medium to convert the adsorbed nitrate salts into their corresponding hydroxide or oxide forms. Crucially, the pH at the substrate surface is monitored in real-time using a precision micro-electrode to ensure that localized pH levels remain within the optimal reaction window, thereby enabling consistent ionic transformation across the entire substrate area.
To finalize the deposition step, a second rinse in distilled water is carried out under laminar flow conditions. This laminar environment ensures that the surface is cleansed without turbulence, thereby preventing any inadvertent ion redistribution that might occur due to localized flow irregularities. To maintain the consistency and reproducibility of the film growth, each cycle is separated by a 10-second ambient exposure wherein the substrate is held within a clean, dust-free acrylic enclosure. This brief air exposure stabilizes the hydration layer on the surface, which plays a critical role in dictating subsequent ion attachment in the following SILAR cycle. The cumulative effect of these highly controlled immersion, rinsing, reaction, and drying protocols across 80 cycles leads to the formation of a conformal, compositionally consistent, and defect-minimized BaO//CeO₂ thin film suitable for advanced electrochemical applications such as asymmetric supercapacitor devices. This embodiment demonstrates not only the detailed process control required for high-performance film synthesis but also the technical efficacy of achieving reproducibility, layer uniformity, and chemically stable deposition critical for scalable device integration.
In an embodiment, dissolution of 3-4 grams of polyvinyl alcohol in 40-50 milliliters of deionized water is performed inside a double-jacketed borosilicate glass reactor equipped with a temperature feedback loop, wherein heating is initiated using a water circulator set to ramp up the temperature at a constant rate of 1.5 K per minute until the solution reaches 348-353 K, wherein the stirring is executed using a four-blade PTFE impeller rotating at 90 rpm for a duration of precisely 1.5 hours before being reduced to 60 rpm for an additional hour to minimize foam formation and microbubble entrapment, wherein the resultant gel is transferred into a polypropylene beaker and allowed to cool passively on a vibration-damped granite surface at ambient conditions without application of forced convection, and wherein the potassium hydroxide solution is introduced using a microdialysis syringe pump at a volumetric flow rate of 0.25 mL per minute under continuous mechanical stirring at 50 rpm for the full 6-7 hour mixing duration, wherein the final mixture is sampled every hour for conductivity measurements using a calibrated four-point probe cell to verify progressive integration of ionic species into the polymer network without batch deviation.
In one embodiment, the preparation of the PVA-KOH gel electrolyte is carried out through a rigorously controlled and reproducible protocol to ensure high ionic homogeneity, structural consistency, and suitability for electrochemical device applications. The process begins with the dissolution of 3-4 grams of polyvinyl alcohol (PVA) in 40-50 milliliters of deionized water inside a double-jacketed borosilicate glass reactor. This reactor is selected for its chemical inertness and thermal stability, and it is equipped with an integrated temperature feedback loop to enable real-time monitoring and precise thermal management throughout the dissolution process. Heating of the system is performed using an external water circulator connected to the jacketed chamber, which ramps up the temperature at a steady rate of 1.5 K per minute. This gradual ramp avoids sudden thermal gradients that could lead to localized degradation or uneven polymer swelling. The target temperature is precisely maintained between 348 K and 353 K, the optimal range for complete PVA dissolution without polymer degradation.
Stirring is initiated using a four-blade PTFE (polytetrafluoroethylene) impeller rotating at 90 rpm, ensuring uniform mechanical mixing without introducing contamination. This stirring continues for exactly 1.5 hours, ensuring complete hydration and chain disentanglement of the polymer. After this period, the rotation speed is reduced to 60 rpm for another hour to suppress foam formation and allow any entrapped microbubbles to gradually escape, thus preventing defects or discontinuities in the resulting gel matrix. Once a clear, viscous solution is achieved, it is transferred to a polypropylene beaker and allowed to cool passively under ambient conditions on a vibration-damped granite slab. This passive cooling phase is executed without any forced convection or airflow, allowing for gradual relaxation of the polymer chains and minimizing thermal stress-induced phase separation or microstructural inconsistencies.
The next step involves the addition of potassium hydroxide (KOH) to convert the PVA solution into an ionically conductive gel. This is accomplished using a microdialysis syringe pump, which introduces the KOH solution at a tightly regulated volumetric flow rate of 0.25 mL per minute directly into the cooled PVA matrix under continuous stirring at 50 rpm. The use of a microdialysis pump ensures that KOH is dosed in a consistent, droplet-wise manner, preventing local ionic oversaturation and promoting uniform diffusion throughout the polymer matrix. This mixing process is continued for a prolonged duration of 6-7 hours to facilitate the full integration of K⁺ and OH⁻ ions into the polymer network, enhancing gelation through ionic interactions and hydrogen bonding.
To assess the progression of ionic integration and ensure batch consistency, the gel mixture is sampled at hourly intervals. Conductivity measurements are performed using a calibrated four-point probe cell, offering high-precision detection of ionic transport properties within the polymer electrolyte. These measurements allow real-time verification of the uniformity and completeness of the mixing process and help to detect any deviations from the expected conductivity curve. Through these precise thermal, mechanical, and chemical control mechanisms, this embodiment enables the production of a robust, electrochemically stable PVA-KOH gel electrolyte tailored for consistent performance in energy storage devices such as asymmetric supercapacitors. The high degree of technical rigor ensures the reproducibility and reliability required to support advanced device assembly and operation.
In an embodiment, the assembly of the asymmetric supercapacitor device is performed inside a nitrogen-filled glovebox maintaining oxygen and moisture levels below 1 ppm, wherein the BaO//CeO₂ thin film-coated conductive substrate is first positioned on a glass alignment plate with laser-etched registration marks, and the PVA-KOH gel electrolyte is cast over it using a Teflon-coated applicator with a fixed height gap of 100 microns, wherein the AC electrode is aligned and placed over the gel-coated first electrode using an optical alignment jig with x-y micrometer screws enabling sub-millimeter accuracy, wherein the entire stacked structure is left undisturbed for 18 hours on a vibration-isolated surface maintained at 295-298 K in a dark enclosure to prevent thermal or photonic polymer relaxation, and wherein pressing is carried out using a hydraulic cold press at a controlled force of 8 N/cm² for 3 minutes using a pair of polished stainless-steel platens whose surfaces are cleaned with isopropanol prior to application, and wherein no post-pressing movement or re-alignment is permitted during the 30-minute post-press rest period to retain consistent interfacial bonding characteristics, and wherein the solid-state electrolyte layer applied between the first and second electrodes is formed into a semi-dry film prior to stacking by spreading the gel over a non-stick PTFE-coated glass surface using a manual rolling bar adjusted to a fixed height of 200 microns and left undisturbed at 293 K for 8 hours, wherein the semi-dried film is then manually peeled and transferred to the BaO//CeO₂ electrode using stainless-steel tweezers under magnification to prevent film cracking or folding, and wherein the interface between the semi-dried electrolyte and both electrodes is further enhanced by applying a controlled rolling pressure of 1 N/cm² using a cylindrical Teflon roller over a 10-second pass, repeated three times from alternating directions.
In one embodiment, the final assembly of the asymmetric supercapacitor device is executed under a tightly controlled inert environment to preserve material integrity, prevent contamination, and ensure robust interfacial bonding between all components. The entire assembly process takes place inside a nitrogen-filled glovebox, where the levels of oxygen and moisture are maintained below 1 part per million (ppm). This ultra-low atmospheric contamination environment is critical to preventing unwanted oxidation of active materials, hydrolysis of electrolyte constituents, and deterioration of electrochemical performance due to ambient exposure.
The process begins by placing the BaO//CeO₂ thin film-coated conductive substrate on a precision-engineered glass alignment plate. This plate is etched with laser-defined registration marks, which serve as visual guides to ensure accurate positioning of the components. Over this base electrode, the PVA-KOH gel electrolyte is applied using a Teflon-coated applicator designed to deposit the gel at a uniform thickness of exactly 100 microns. The use of Teflon ensures chemical inertness and smooth application, preventing interaction between the gel and the applicator surface. Following the gel deposition, the activated carbon (AC) electrode is carefully aligned and placed atop the gel-coated surface. This alignment is performed with the aid of an optical alignment jig fitted with x-y micrometer screws, allowing adjustments at sub-millimeter resolution. Such fine alignment ensures optimal overlap of the active regions, reducing internal resistance and promoting uniform charge distribution during device operation.
Once stacked, the layered assembly is left undisturbed for a period of 18 hours on a vibration-isolated platform. The temperature is held between 295-298 K in a dark enclosure to prevent any thermal fluctuations or photonic relaxation of the gel matrix. This rest period is crucial for promoting interfacial wetting and physical relaxation of the polymer chains, which in turn improves the ionic contact across electrode interfaces. Following this stabilization, the device undergoes a pressing step using a hydraulic cold press operated at a controlled force of 8 N/cm² for a duration of 3 minutes. The press utilizes two highly polished stainless-steel platens, each thoroughly cleaned with isopropanol immediately before use to eliminate residual particulates or oils. The precise force and duration facilitate strong, uniform contact between the layers, while minimizing mechanical damage or gel extrusion.
After pressing, the device remains in place between the press platens without any applied force for an additional 30 minutes. This resting period is essential to lock in the interfacial conformation achieved during pressing, allowing any remaining viscoelastic stress in the polymer matrix to dissipate naturally. Importantly, no further movement or re-alignment is permitted during this phase to avoid disrupting the delicate bonding architecture between the electrodes and the gel layer.
In parallel, the solid-state electrolyte layer is prepared in the form of a semi-dry film before stacking. The PVA-KOH gel is uniformly spread over a PTFE-coated glass surface using a manual rolling bar calibrated to a height of 200 microns. The coated gel is then left to partially dry at 293 K for 8 hours, allowing solvent evaporation to reach a controlled semi-solid state that balances flexibility with structural cohesion. Once the desired consistency is achieved, the semi-dried film is carefully peeled from the substrate using stainless-steel tweezers under optical magnification. This manual transfer process, performed under close visual inspection, ensures that the film is not cracked or folded, preserving its structural integrity.
Upon placement over the BaO//CeO₂ electrode, the interface between the semi-dry gel and both electrodes is further reinforced using a cylindrical Teflon roller. A controlled rolling pressure of 1 N/cm² is applied in a 10-second pass, repeated three times with alternating directional strokes to uniformly consolidate the layers. This rolling operation promotes molecular interpenetration at the electrolyte-electrode interface and eliminates microscopic air gaps that could impair electrochemical performance. The resulting device structure offers high interfacial stability, minimal internal resistance, and optimized ionic mobility—all of which are essential for delivering superior energy storage performance in solid-state asymmetric supercapacitor systems.
In an embodiment, the preparation of the activated carbon electrode comprises selecting activated carbon particles with a surface area range of 1000-1200 m²/g and particle diameter distribution between 20-50 microns, wherein the AC is gradually added to the PVA solution over a period of 30 minutes using a powder funnel with magnetic vibration assistance to prevent clumping, wherein the PVA-AC mixture is stirred using a coaxial paddle blade at 343-353 K for 2 hours with interspersed 5-minute pauses every 30 minutes to allow thermal equilibration, wherein the slurry is poured into a PTFE-coated mold and stored in a vacuum desiccator maintained at −0.08 MPa for 12 hours to remove entrapped air, wherein the slurry is applied onto the substrate using a doctor blade with an adjustable micrometer-controlled gap of 150 microns at a draw speed of 10 mm/s, and wherein the drying step includes a two-stage thermal cycle: ambient air drying for 4 hours followed by heating in a muffle furnace at 353 K for 6.5 hours with a ramp rate of 1 K/min and intermediate hold at 333 K for 2 hours to facilitate gradual solvent release and crystallization of the film structure, and wherein the activated carbon used in the AC electrode is pre-dried at 393 K in a vacuum oven for 6 hours prior to addition to the PVA solution to remove residual moisture, wherein the prepared AC-PVA slurry is continuously degassed during the 2-hour stirring phase using a diaphragm vacuum pump connected to a side-arm of the mixing chamber, wherein the doctor blade application is conducted in a cleanroom environment classified as ISO Class 7 to prevent airborne particulate inclusion in the wet film, and wherein the substrate upon which the slurry is coated is pre-heated to 323 K using a resistive heating plate to promote immediate solvent flashing at the substrate interface.
In one embodiment, the fabrication of the activated carbon (AC) electrode, a critical component of the asymmetric supercapacitor device, is conducted through a series of carefully controlled steps that ensure structural homogeneity, optimal porosity, and excellent electrochemical compatibility. The process begins with the selection of high-performance activated carbon particles exhibiting a specific surface area in the range of 1000-1200 m²/g and a particle diameter distribution between 20-50 microns. This surface area ensures sufficient electroactive sites for charge storage, while the controlled particle size aids in forming a stable dispersion within the polymer matrix and promotes uniform film formation during coating.
Prior to mixing, the activated carbon powder is subjected to a pre-drying step in a vacuum oven at 393 K for 6 hours. This treatment removes residual moisture that could otherwise interfere with polymer bonding and degrade the ionic transport properties of the resulting electrode. Once dried, the AC is gradually introduced into a pre-prepared PVA solution over a 30-minute period using a powder funnel equipped with magnetic vibration assistance. This vibration mechanism prevents agglomeration and ensures even distribution of the carbon particles into the viscous polymer solution.
The AC-PVA mixture is then subjected to mechanical stirring using a coaxial paddle blade within a temperature-controlled reactor maintained between 343-353 K. The stirring is carried out for 2 hours, with deliberate 5-minute pauses every 30 minutes to allow for thermal equilibration and to reduce mechanical stress accumulation in the fluid. Concurrently, a diaphragm vacuum pump is connected to a side-arm of the mixing vessel to enable continuous degassing of the slurry during the mixing phase. This step is essential to remove dissolved gases and microscopic air pockets that could compromise the uniformity of the film and its dielectric behavior.
Once homogenized and degassed, the slurry is transferred into a PTFE-coated mold and placed inside a vacuum desiccator maintained at −0.08 MPa for 12 hours. This additional degassing step ensures the elimination of residual air bubbles, resulting in a smooth and crack-free film upon drying. For coating onto the substrate, the slurry is applied using a precision doctor blade with a micrometer-controlled gap set to 150 microns. The draw speed is maintained at 10 mm/s to produce a consistent and defect-free wet film. The substrate onto which the slurry is applied is pre-heated to 323 K using a resistive heating plate. This localized heating promotes immediate solvent evaporation (flashing) at the interface, preventing pooling and improving adhesion of the AC layer to the substrate.
To complete the film formation, the wet-coated substrate undergoes a two-stage thermal drying cycle. First, it is left to air-dry at ambient temperature for 4 hours to facilitate gentle initial solvent evaporation, allowing polymer chains to begin setting without inducing internal stress. This is followed by controlled heating in a muffle furnace set to a final temperature of 353 K for 6.5 hours. The heating process includes a ramp-up rate of 1 K/min and an intermediate hold at 333 K for 2 hours. This intermediate plateau allows for gradual solvent release and polymer restructuring, promoting crystallinity and uniform mechanical properties across the film.
To prevent contamination and maintain film purity, the entire coating process is conducted within an ISO Class 7 cleanroom. This level of air cleanliness ensures minimal particulate interference during the sensitive doctor blade application stage, which is vital for reproducibility and consistent electrochemical performance across batches. The resulting AC electrode exhibits excellent structural integrity, low internal resistance, and high surface area accessibility, all of which contribute to the enhanced energy density and cyclability of the final supercapacitor device. This embodiment thus reflects a robust, scalable, and technically validated pathway for the fabrication of high-performance activated carbon electrodes compatible with advanced solid-state energy storage systems.
In an embodiment, the substrate used for BaO//CeO₂ film deposition is pre-treated by ultrasonication in a sequential solvent bath of acetone, ethanol, and deionized water, each for 15 minutes, followed by a drying step in a hot-air oven at 323 K for 30 minutes, wherein the substrate surface is then plasma-treated using low-pressure oxygen plasma at 100 W for 5 minutes to enhance surface hydrophilicity and electrostatic adsorption capacity, and wherein prior to each immersion cycle in the precursor solution, the substrate is held at a 10° inclination within the bath to initiate gravitational-driven ion distribution along the surface to create a slight compositional gradient across the substrate length.
In one embodiment, the substrate preparation process for BaO//CeO₂ thin film deposition is executed with a focus on achieving high surface cleanliness, enhanced wettability, and optimized ion adsorption characteristics, all of which are essential for the successful growth of uniform and defect-minimized thin films via the successive ionic layer adsorption and reaction (SILAR) technique. The initial pre-treatment step involves ultrasonication in a sequence of solvent baths—acetone, ethanol, and deionized water—each for a duration of 15 minutes. Ultrasonication introduces high-frequency acoustic waves that generate microcavitation within the liquid medium, effectively dislodging contaminants such as oils, organic residues, and particulates from the substrate surface. Acetone serves to remove non-polar organic residues, ethanol targets semi-polar contaminants, and deionized water eliminates remaining polar impurities, ensuring comprehensive surface decontamination.
Following this cleaning sequence, the substrate is dried in a hot-air oven maintained at 323 K for 30 minutes. This step ensures the complete evaporation of residual solvents while preserving the substrate's structural integrity. The gentle thermal treatment promotes the desorption of physisorbed water molecules and primes the surface for subsequent plasma activation. Once dried, the substrate undergoes plasma treatment using low-pressure oxygen plasma at a power setting of 100 W for a duration of 5 minutes. The oxygen plasma reacts with surface-bound carbonaceous species and introduces reactive hydroxyl and oxygen-containing functional groups, significantly enhancing the surface hydrophilicity. Additionally, this treatment increases the substrate's electrostatic adsorption capacity, enabling more effective ionic anchoring during the initial stages of precursor immersion.
To further manipulate the distribution of ions during the SILAR deposition process, the substrate is positioned at a 10° inclination angle within the precursor solution bath during each cycle. This inclined orientation utilizes gravity-driven fluid dynamics to induce a mild, continuous ion flux across the substrate surface. As a result, a slight but deliberate compositional gradient is established along the substrate's length. This gradient can be tailored to improve electrochemical performance by inducing anisotropy in charge transport pathways, which is particularly advantageous for asymmetric device architectures where directional conductivity may be desirable.
Together, these preparatory steps create a substrate surface that is chemically active, physically clean, and geometrically oriented to maximize the efficacy of Ba²⁺ and Ce³⁺ ion adsorption during SILAR. The enhancement in surface reactivity and tailored ion distribution ultimately contribute to superior film adhesion, homogeneity, and long-term stability of the BaO//CeO₂ composite films, directly supporting the performance and reliability of the assembled supercapacitor devices.
In an embodiment, the gelled PVA-KOH electrolyte is subjected to centrifugation at 3000 rpm for 10 minutes at ambient temperature immediately after the 7-hour mixing cycle to remove macro-aggregates and inhomogeneous polymer clusters, wherein the supernatant gel is carefully decanted and cast into a sterile polypropylene Petri dish lined with a Teflon sheet, and wherein the gel is then allowed to stand in a low-humidity desiccation chamber for 24 hours without forced air exposure, under a silica-gel regulated environment to achieve gradual phase stabilization and uniform gel thickness with minimum internal strain.
In one embodiment, to ensure the structural uniformity and electrochemical consistency of the PVA-KOH gel electrolyte, the gel mixture, upon completion of the extended 7-hour mixing and ion integration process, undergoes a post-processing step involving high-speed centrifugation. Specifically, the gel is subjected to centrifugal separation at 3000 rpm for a duration of 10 minutes at ambient temperature. This centrifugal force effectively separates macro-aggregates, inhomogeneous polymer clusters, and any residual insoluble particulates from the bulk gel matrix, resulting in a refined supernatant that is free from structural anomalies that could impede ionic transport or compromise mechanical stability.
Following centrifugation, the clarified supernatant is decanted with care to avoid disturbing the settled impurities at the base of the centrifuge tube. This purified gel is then cast into a sterile polypropylene Petri dish lined with a chemically inert Teflon sheet. The use of a Teflon liner prevents adhesion of the gel to the dish surface during the drying phase and allows for easy removal of the gel film post-casting without mechanical disruption. Casting into a flat −bottomed dish promotes uniform spreading of the gel, thereby setting the stage for consistent thickness across the entire film area.
To complete the solidification process and achieve optimal phase stabilization, the cast gel is placed into a low-humidity desiccation chamber for 24 hours. The chamber environment is regulated using silica gel to passively maintain a controlled humidity level without the use of forced air convection, which could induce uneven drying or surface skin formation. This slow and controlled drying regime allows the gel to gradually lose excess moisture, thereby minimizing internal stress gradients that might otherwise cause cracking, warping, or non-uniform ionic diffusion pathways.
By allowing the gel to solidify under these carefully managed ambient conditions, the final PVA-KOH electrolyte achieves a uniform thickness, a stable molecular conformation, and minimal internal strain—all of which are essential to ensuring high ionic conductivity, mechanical robustness, and long-term performance reliability in the assembled asymmetric supercapacitor. This embodiment effectively bridges the transition from a fluidic gel state to a mechanically integrated solid-state electrolyte, enabling precision-controlled application in multilayer device architectures.
In an embodiment, the annealing of the BaO//CeO₂ thin film following SILAR deposition is conducted in a programmable muffle furnace with a three-stage thermal ramp: initially increasing from room temperature to 473 K over 30 minutes, followed by a hold at 473 K for 15 minutes, then ramping to 573 K over another 30 minutes and holding for 1 hour, wherein the annealing chamber includes a sacrificial ceramic crucible loaded with activated alumina to capture residual nitrates and prevent re-adsorption on the film surface, and wherein the post-annealing cooling is conducted inside the furnace by passive cooling over 3 hours with the furnace door slightly ajar.
In one embodiment, the post-deposition annealing of the BaO//CeO₂ thin film—critical for enhancing film crystallinity, phase purity, and electrochemical activity—is executed through a carefully structured thermal treatment using a programmable muffle furnace. This process follows the completion of 80 SILAR deposition cycles and is designed to drive out residual nitrates, promote oxide phase formation, and optimize interfacial bonding within the film matrix. The annealing protocol follows a three-stage thermal ramp sequence for controlled temperature elevation and stabilization.
Initially, the temperature is gradually increased from room temperature to 473 K over a 30-minute period. This controlled ramp avoids thermal shock, thereby preventing delamination or stress-induced cracking in the thin film and underlying substrate. At 473 K, the system holds for 15 minutes to allow intermediate decomposition of volatile precursor residues and partial phase transformation. This dwell period helps in initiating the structural reorganization of the Ba and Ce components into their respective oxide forms while limiting grain coarsening. Following this, the temperature is further increased to 573 K over another 30 minutes. The furnace then maintains this elevated temperature for a full hour, ensuring complete decomposition of any remaining nitrate species and promoting crystallization and densification of the BaO and CeO₂ domains. The dual-stage ramping ensures both chemical conversion and microstructural ordering while minimizing thermal gradients that could cause interfacial stress.
To prevent the re-adsorption of decomposition byproducts—particularly nitrate species—onto the film surface during this thermally active phase, the annealing chamber is supplemented with a sacrificial ceramic crucible containing activated alumina. The activated alumina functions as a reactive sink, adsorbing vapor-phase nitrate derivatives and other volatile organics released during annealing, thereby maintaining a cleaner annealing environment and preserving the purity of the BaO//CeO₂ surface.
Upon completion of the high-temperature hold, the system is allowed to cool passively over a 3-hour duration within the closed muffle furnace. The furnace door is kept slightly ajar to promote gradual cooling via natural convection, avoiding abrupt temperature changes that could result in film cracking, warping, or undesirable grain restructuring. This slow cooling also facilitates stress relaxation within the oxide matrix, thereby enhancing the mechanical and electrochemical stability of the final film.
The annealing sequence thus not only ensures optimal phase formation of the BaO and CeO₂ layers but also improves film adhesion, structural integrity, and ionic mobility—key parameters for achieving high-performance behavior in the assembled asymmetric supercapacitor. By meticulously controlling the temperature profile and environmental purity during thermal processing, this embodiment offers a highly reproducible and technically robust pathway for activating the functional properties of SILAR-deposited thin films.
In an embodiment, the PVA-KOH gel is subjected to cross-linking stabilization by exposure to glutaraldehyde vapors in a sealed chamber for a period of 20 minutes at room temperature after initial gel formation and prior to device assembly, wherein the exposure is conducted using a desiccator-based vapor diffusion method with a 2% glutaraldehyde solution placed in a shallow dish under the gel-containing tray, and wherein the resulting cross-linked gel is verified by FTIR spectroscopy confirming the presence of C═N imine bonding peaks in the range of 1650-1700 cm⁻¹, indicating successful Schiff base formation between aldehyde groups and hydroxyl functionalities of the PVA, and wherein the PVA solution prior to gel formation is filtered through a 0.45-micron polypropylene filter to remove insoluble particulates, and wherein the KOH solution is pre-heated to 318 K before mixing to minimize abrupt thermal shocks during addition, wherein during the mixing stage, a rotating magnetic stir bar with a rare-earth magnet is used inside a low-friction PTFE-coated vessel to avoid ion contamination, and wherein a digital refractometer is used at 1-hour intervals during mixing to monitor real-time refractive index variation as an indirect measure of homogeneity in ion-polymer interaction; and wherein after mixing the PVA and KOH to form the gel, the sample is subjected to a series of freeze-thaw cycles comprising three repetitions of freezing at −20° C. for 2 hours followed by thawing at 298 K for 1 hour, wherein the cycles are executed inside a programmable freezer-thaw chamber equipped with an internal temperature logger, and wherein the gel viscosity after the third cycle is measured using a rotational viscometer at a shear rate of 10 s⁻¹ to confirm that the thixotropic behavior remains within a pre-defined viscosity range of 1200-1500 cP.
In one embodiment, the stabilization of the PVA-KOH gel electrolyte is enhanced through a well-defined cross-linking protocol designed to improve mechanical integrity, water retention stability, and electrochemical durability of the gel when integrated into an asymmetric supercapacitor device. After initial gel formation through the homogenous mixing of PVA and KOH, the resulting gel is subjected to cross-linking by exposure to glutaraldehyde vapors in a sealed environment. This cross-linking step is performed using a desiccator-based vapor diffusion method, where a 2% aqueous glutaraldehyde solution is placed in a shallow dish at the bottom of the chamber, and the gel-containing tray is suspended above it. The system is sealed and maintained at room temperature for 20 minutes, allowing the vapor-phase aldehyde molecules to diffuse and react with hydroxyl groups on the PVA chains.
The interaction between glutaraldehyde and PVA forms imine bonds via Schiff base reactions, which create stable C═N linkages, effectively cross-linking the polymer chains and enhancing the gel's structural network. The success of the cross-linking reaction is confirmed through Fourier-transform infrared (FTIR) spectroscopy, where the appearance of characteristic absorption peaks between 1650 and 1700 cm⁻¹ provides direct evidence of the C═N bond formation, indicating effective cross-linking.
Prior to gel formation, the PVA solution is filtered through a 0.45-micron polypropylene filter to remove insoluble impurities and prevent particulate-induced inhomogeneities. The KOH solution used for gelation is pre-heated to 318 K to bring it closer to the thermal state of the PVA solution, thus avoiding abrupt thermal gradients that could compromise gel consistency or lead to premature localized cross-linking. The mixing of PVA and KOH is performed in a low-friction PTFE-coated vessel using a rotating magnetic stir bar embedded with a rare-earth magnet to ensure efficient mixing while avoiding contamination from metallic sources. Throughout the 6-7 hour mixing duration, a digital refractometer is used to monitor the refractive index of the gel at 1-hour intervals. Changes in the refractive index serve as an indirect measure of homogeneity and the progression of ion-polymer interactions, helping to maintain batch-to-batch consistency.
After the mixing and vapor cross-linking stages, the gel is subjected to a series of controlled freeze-thaw cycles to further enhance its internal structural ordering and mechanical toughness. This process involves three repeated cycles of freezing the gel at −20° C. for 2 hours followed by thawing at 298 K for 1 hour, carried out in a programmable freezer-thaw chamber that includes an internal temperature logger for real-time thermal tracking. These cycles encourage the formation of physical cross-links by promoting microcrystallite domains within the PVA network, resulting in a physically reinforced gel matrix. Post-cycling, the gel's thixotropic behavior is evaluated using a rotational viscometer set at a shear rate of 10 s⁻¹. The viscosity is measured to ensure it falls within a targeted range of 1200-1500 cP, confirming that the gel exhibits the desired viscoelastic properties necessary for stable electrode-electrolyte interaction in the supercapacitor device.
Collectively, this embodiment integrates chemical cross-linking, thermal stabilization, and rheological control to produce a robust, ion-conductive PVA-KOH gel electrolyte. These process conditions and validation steps ensure superior mechanical flexibility, enhanced ionic mobility, and long-term electrochemical performance within the solid-state architecture of the asymmetric supercapacitor.
In an embodiment, the precursor solution used for SILAR deposition is magnetically stirred at 200 rpm throughout the deposition process using an overhead stirrer to prevent ion settling, and wherein the concentration of barium and cerium nitrates is verified by UV-Vis spectroscopy every 10 cycles by sampling 1 mL of solution and comparing absorption peaks at 300-400 nm, and wherein any deviation beyond ±5% of absorbance is corrected by replenishing the solution with freshly prepared precursor maintaining the original molar concentration ratio, and wherein the pressing step involves placing the fully assembled device stack between two layers of soft silicone elastomer sheets with a Shore A hardness of 30 to distribute pressure evenly, and wherein a load cell is integrated into the hydraulic press mechanism to record real-time pressure data, wherein the pressing duration is precisely controlled by a timer-relay system and terminated automatically once the set force threshold of 8 N/cm² is maintained for a full 180 seconds, and wherein the assembly is then allowed to rest between the press platens for an additional 5 minutes without applied force to preserve interfacial conformation developed during pressing.
In one embodiment, to ensure the consistency, repeatability, and structural uniformity of the BaO//CeO₂ film during the successive ionic layer adsorption and reaction (SILAR) process, the precursor solution comprising barium and cerium nitrates is continuously magnetically stirred using an overhead stirrer at a fixed speed of 200 rpm throughout the entire deposition process. This constant stirring prevents sedimentation of ions and ensures homogeneous distribution of ionic species within the solution, which is essential for achieving reproducible adsorption on the substrate surface during each of the 80 cycles.
To maintain chemical accuracy and verify the stoichiometric balance of the precursor throughout the deposition, a 1 mL sample of the solution is withdrawn every 10 SILAR cycles and analyzed using UV-Vis spectroscopy. The absorption peaks in the 300-400 nm range, characteristic of the nitrate complexes of barium and cerium, are monitored to track any deviation in concentration. If the absorbance deviates by more than ±5% from the initial calibration reference, the precursor solution is replenished with freshly prepared barium and cerium nitrate stock solutions in the original molar ratio. This proactive replenishment ensures that deposition conditions remain chemically stable and that ionic depletion does not compromise film thickness or composition uniformity during later cycles.
Once the BaO//CeO₂ thin film is fully deposited and integrated into the device stack, a precision-controlled pressing step is initiated to ensure proper layer adhesion and minimize interfacial resistance. The device stack, which includes the BaO//CeO₂ electrode, the PVA-KOH gel electrolyte, and the activated carbon counter electrode, is placed between two soft silicone elastomer sheets with a Shore A hardness rating of 30. These elastomeric layers act as uniform pressure distributors, accommodating minor surface roughness and preventing localized stress concentrations that could damage the thin films or gel layer.
Pressing is carried out using a hydraulic press equipped with a load cell for real-time force monitoring. The press system is governed by a timer-relay mechanism, which ensures precise control of the pressing sequence. The pressing force is applied until the load cell detects a sustained pressure of 8 N/cm², at which point a timer is activated to maintain this force for exactly 180 seconds. This automated regulation guarantees consistency across batches and eliminates operator-induced variability.
Following the pressing cycle, the device is not immediately removed but is instead allowed to remain positioned between the press platens for an additional 5-minute rest period, without any applied load. This controlled rest allows the compressed gel layer to conform and stabilize at the interface of both electrodes, preserving the pressure-induced alignment and contact integrity. It also prevents elastic rebound or structural relaxation that might otherwise occur if the device were abruptly removed after pressing.
In an embodiment, the slurry-dried AC electrode on the substrate is first characterized using a laser profilometer to assess thickness uniformity across the surface area at 100-micron resolution, and wherein areas deviating by more than ±10 microns from the average thickness are excluded from further device assembly, and wherein the heat treatment in the muffle furnace is performed using a sintering program with a controlled rise of 2 K per minute, a hold at 353 K for 6.5 hours, and a natural cool-down in a closed furnace environment with no door opening until the internal temperature reaches below 323 K.
In one embodiment, to ensure the dimensional precision and electrochemical consistency of the activated carbon (AC) electrode prior to device integration, the dried AC slurry-coated substrate undergoes detailed surface profiling using a high-resolution laser profilometer. This non-contact measurement technique is performed at a spatial resolution of 100 microns across the entire coated surface, enabling accurate detection of film thickness variations. The profilometer generates a thickness map, from which the average thickness is calculated and compared against local deviations. Any region found to vary beyond ±10 microns from the mean thickness is flagged and excluded from further device assembly, as non-uniformity in electrode thickness can lead to local current density disparities, reduced capacitance, or premature device failure due to uneven stress distribution or incomplete electrolyte penetration.
Following this selection process, the qualified AC electrodes are subjected to thermal treatment in a programmable muffle furnace using a finely tuned sintering program. The thermal cycle is initiated with a temperature ramp of 2 K per minute, which gradually brings the electrode up to 353 K, minimizing thermal shock and allowing gradual solvent release from the film. This slow ramp is crucial to prevent film delamination, internal stress buildup, and cracking, particularly for thick or high-loading AC films.
Upon reaching 353 K, the furnace maintains this temperature for 6.5 hours, allowing for complete solvent evaporation and the gradual densification of the polymer-carbon composite matrix. This thermal hold facilitates the formation of a mechanically cohesive and electrochemically stable film with improved interparticle contact and polymer chain alignment, which is essential for ionic conductivity and structural durability during charge/discharge cycling.
After the thermal hold, the furnace is allowed to cool passively in a closed condition, with the door kept shut until the internal temperature naturally falls below 323 K. This controlled cool-down avoids the introduction of external thermal gradients or drafts that could cause differential contraction or introduce microfractures in the dried film. The natural relaxation of the film under uniform thermal conditions ensures a stress-free structure and maintains the mechanical integrity and flatness of the electrode. Through this embodiment, a uniform, defect-free, and dimensionally consistent AC electrode is produced, providing a reliable electrochemical interface for integration into the asymmetric supercapacitor. This method not only improves device yield and performance consistency but also reinforces the mechanical stability of the active layer under operational stress, contributing significantly to the overall energy efficiency and lifecycle of the device.
In an embodiment, prior to the device assembly, each electrode is weighed using an analytical balance with 0.01 mg sensitivity and the surface area is measured using a digital caliper, and wherein electrodes are selected for assembly only if the weight-to-area ratio for both electrodes falls within a range of 1.20-1.30 mg/cm² to maintain symmetrical energy distribution, and wherein after assembly and pressing, the final device is encapsulated in a non-conductive heat −shrink polymer sleeve under mild heating to provide mechanical protection without affecting electrochemical behaviour, and wherein the interfacial compatibility between the BaO//CeO₂ thin film and the solid-state electrolyte is enhanced by applying a plasma surface activation treatment on the dried thin film using a radiofrequency oxygen plasma source at 50 W power for 3 minutes immediately prior to electrolyte application, wherein this activation step is carried out inside a vacuum-compatible surface modification chamber equipped with a rotating sample stage set to 10 rpm, and wherein post-plasma treatment, the film is transferred directly to the assembly station without exposure to ambient air, using an inert atmosphere sealed transfer capsule to preserve the activated surface reactivity.
In one embodiment, to ensure optimal electrochemical symmetry and long-term operational stability of the asymmetric supercapacitor device, a precision pre-assembly quality control protocol is employed, focusing on electrode mass balance and surface compatibility. Before the assembly process begins, each electrode—both the BaO//CeO₂-coated and the activated carbon (AC) counterpart—is individually weighed using a high-precision analytical balance with a sensitivity of 0.01 mg. Simultaneously, the surface area of each electrode is measured using a digital caliper to calculate the weight-to-area ratio (mg/cm²). Only those electrodes with a weight-to-area ratio falling within the range of 1.20 to 1.30 mg/cm² are selected for final assembly. This strict selection criterion is crucial to achieving symmetrical energy distribution during charge-discharge cycles, preventing current imbalances that could lead to localized heating, accelerated degradation, or reduced capacitance retention over time.
After successful assembly and cold-pressing under controlled force conditions, the device stack is encapsulated in a non-conductive heat-shrink polymer sleeve. This encapsulation process is performed under mild heating, sufficient to shrink the polymer around the device structure to provide mechanical protection, edge sealing, and environmental isolation, but without inducing thermal stress or altering the electrochemical characteristics of the internal components. The encapsulant is selected for its inert nature, mechanical flexibility, and dielectric stability to ensure it does not interact with or degrade the functional layers during device operation.
To further enhance the interfacial adhesion and ion transport characteristics between the BaO//CeO₂ thin film and the solid-state PVA-KOH electrolyte, a plasma surface activation treatment is applied immediately prior to electrolyte deposition. The dried thin film is placed inside a vacuum-compatible surface modification chamber, where it is exposed to radiofrequency (RF) oxygen plasma at a power level of 50 W for a duration of 3 minutes. The plasma treatment introduces polar functional groups (such as hydroxyl and carbonyl) and increases the surface energy of the film, significantly improving wettability and electrostatic interaction with the gel electrolyte. The film is mounted on a rotating sample stage set to 10 rpm during the plasma exposure to ensure uniform treatment across the entire surface area, avoiding spatial variability in electrolyte adhesion or performance.
Immediately after plasma activation, the treated BaO//CeO₂ electrode is transferred to the assembly station using an inert atmosphere-sealed transfer capsule. This capsule isolates the film from ambient air to preserve its activated surface state and prevent re-contamination or deactivation from moisture and atmospheric oxygen. By maintaining the surface's high reactivity until the gel is applied, this process maximizes interfacial compatibility and promotes seamless ionic integration between the film and the electrolyte layer.
This embodiment thus integrates meticulous mass balancing, encapsulation, and surface activation to construct a high-performance asymmetric supercapacitor device characterized by balanced energy dynamics, mechanical robustness, and optimal electrode-electrolyte interfaces—ensuring high capacitance, low ESR (equivalent series resistance), and durable cycling stability.
In an embodiment, the surface roughness of the dried BaO//CeO₂ thin film is characterized using atomic force microscopy (AFM) in tapping mode, and only films exhibiting a root mean square (RMS) roughness between 10 and 20 nanometers over a 10 μm×10 μm scan area are selected for device assembly, wherein the AFM measurements are conducted using a silicon nitride cantilever with a nominal tip radius of 8 nm, and wherein this roughness threshold is used to define optimal interfacial contact conditions between the electrode and the gel electrolyte to facilitate uniform ion migration pathways.
In one embodiment, the surface characterization of the BaO//CeO₂ thin film, following its deposition and annealing, is conducted with high-resolution atomic force microscopy (AFM) to ensure that only films with ideal surface morphology proceed to device integration. This surface evaluation is performed in tapping mode, a non-destructive AFM technique that minimizes lateral shear forces during scanning and is particularly well-suited for assessing delicate thin films. The AFM scans are carried out over a defined 10 μm×10 μm area to capture a representative section of the film's microtopography with nanometer-level resolution.
A silicon nitride cantilever with a nominal tip radius of 8 nm is employed for the scanning operation. The small tip radius is essential for accurately tracing fine topographical features and resolving nanoscale peaks and valleys across the film surface. The resulting surface data is quantitatively analyzed to determine the root mean square (RMS) roughness of the film, a critical parameter that reflects both the vertical deviations and overall texture uniformity of the surface. Only those BaO//CeO₂ films that demonstrate an RMS roughness within the strict range of 10 to 20 nanometers are considered acceptable for use in the final device assembly.
This specific roughness window is chosen based on its proven ability to promote optimal interfacial contact between the electrode and the solid-state PVA-KOH gel electrolyte. Surfaces that are too smooth may hinder mechanical adhesion and reduce electrolyte wetting, while excessively rough surfaces can lead to localized electric field concentration, irregular ion distribution, and increased risk of delamination or interfacial degradation. By maintaining the RMS roughness within this carefully defined threshold, a balance is achieved that facilitates uniform gel penetration into surface asperities, enhances electrochemical coupling, and supports stable ion migration across the electrode-electrolyte interface. Thus, this embodiment ensures that only morphologically optimized BaO//CeO₂ films, verified through nanoscale surface metrology, are incorporated into the asymmetric supercapacitor architecture. This rigorous control over surface topology directly contributes to improved device performance, including lower series resistance, enhanced capacitance, and superior cycle life—all essential attributes for the development of high-efficiency solid-state energy storage systems.
In an embodiment, during the mixing of activated carbon into the PVA solution, the electrical conductivity of the slurry is measured in real-time using a stainless-steel electrode pair inserted into the solution at a fixed separation of 10 mm, connected to a conductivity meter with a resolution of 0.1 μS/cm, and wherein the AC addition is paused intermittently every 5 minutes during the 30-minute dispersion process to allow for homogenization equilibration, and resumed only when the conductivity increase between two successive readings is less than 2%, thereby confirming stabilization of the particle-polymer ionic interface before further addition, wherein the final assembled supercapacitor device is subjected to a compression-relaxation fatigue test consisting of 100 manual pressing cycles applied using a 1 kg force across the surface in a custom-fabricated jig to simulate real-world mechanical stress, wherein the device is visually monitored under an optical microscope after every 25 cycles to detect delamination or cracking, and wherein devices that show surface microfractures or electrode gel separation exceeding 5 microns in width are excluded from electrochemical evaluation, and wherein the drying of the activated carbon electrode layer on the substrate includes a step of placing the wet-coated substrate over a vibrating hotplate set to 323 K and oscillating at 15 Hz with 1 mm vertical amplitude for the first 30 minutes, followed by transfer to a vacuum oven at 323 K for 6 hours with pressure maintained at −0.09 MPa, wherein the transition between steps is limited to less than 1 minute and conducted under a nitrogen environment to minimize water uptake from ambient air.
In one embodiment, the integration of activated carbon (AC) into the PVA matrix to form a uniform, conductive electrode slurry is governed by real-time monitoring of slurry conductivity to precisely control the particle-polymer ionic interface. During the 30-minute dispersion process, activated carbon is incrementally added to the PVA solution, with conductivity measurements taken in real time using a stainless-steel electrode pair fixed at a 10 mm separation and connected to a high-resolution conductivity meter with 0.1 μS/cm sensitivity. This setup allows for continuous feedback on the dispersion's ionic characteristics as AC is introduced, which is critical because activated carbon can adsorb free ions and alter the local ionic environment within the gel.
To ensure proper homogenization and prevent premature saturation or localized agglomeration, the addition of AC is paused every 5 minutes. During each pause, the dispersion is allowed to equilibrate, and successive conductivity readings are recorded. The addition of AC is only resumed when the change in conductivity between two consecutive readings is less than 2%, indicating that the polymer matrix has reached an ionic and particle equilibrium state and is ready to integrate additional AC without destabilizing the system. This dynamic and feedback-driven approach ensures uniform ionic distribution, prevents clumping of carbon particles, and supports a stable conductive network throughout the slurry.
Following the preparation and coating of the AC-PVA slurry onto the substrate, the electrode is dried in a two-step process optimized to minimize structural stress and improve film uniformity. First, the freshly coated substrate is placed on a vibrating hotplate maintained at 323 K, oscillating at 15 Hz with a 1 mm vertical amplitude for 30 minutes. This vibration-assisted drying facilitates solvent evaporation while simultaneously preventing the formation of surface skin or internal voids by keeping the slurry dynamically leveled. After this initial step, the substrate is immediately transferred—within 1 minute—to a vacuum oven also set at 323 K. The oven is held at a pressure of −0.09 MPa for 6 hours to promote thorough solvent removal in a low-humidity, low-pressure environment. This transfer is conducted under a nitrogen atmosphere to prevent moisture uptake, which could interfere with subsequent electrode performance or electrolyte compatibility.
Once the device is fully assembled and pressed, it undergoes mechanical robustness validation through a compression-relaxation fatigue test designed to simulate real-world handling and operational stress. The test consists of 100 manual pressing cycles applied uniformly across the device surface using a 1 kg force, delivered via a custom-fabricated jig to maintain consistency in pressure application. After every 25 cycles, the device is examined under an optical microscope to inspect for delamination, cracking, or gel-electrode separation. Devices that exhibit any surface microfractures or interfacial separation exceeding 5 microns in width are disqualified from further electrochemical characterization, as such defects compromise performance integrity and longevity.
In an embodiment, the BaO//CeO₂-coated substrate is pre-baked in a forced-convection oven at 373 K for 15 minutes immediately prior to application of the gel electrolyte layer, wherein the substrate is clamped on a thermally conductive aluminum block during pre-baking to achieve uniform heating, and wherein the gel is applied within 60 seconds of substrate removal from the oven, using a calibrated micropipette in a circular pattern from center to edge while rotating the substrate at 10 rpm, promoting centrifugal spreading and eliminating gel trapping at the periphery, and wherein the gel electrolyte and the BaO//CeO₂ electrode interface is thermally conditioned by mild heating using an IR lamp at a distance of 10 cm for 10 minutes after stacking and before pressing, wherein the lamp is controlled using a digital timer and the surface temperature of the device is monitored by a non-contact IR thermometer, and wherein the temperature is maintained within the range of 308-313 K throughout the conditioning step, enhancing softening and molecular interpenetration at the interface without initiating premature degradation of the polymer matrix, and wherein the initial charging of the assembled device is performed using a programmable source meter that applies a stepwise voltage increase from 0 to 1.5 V in increments of 0.1 V, holding each step for 60 seconds under open-circuit conditions before proceeding, and wherein current response is recorded every 0.5 seconds using a 24-bit resolution data acquisition system.
In one embodiment, to ensure optimal adhesion, uniform wetting, and strong ionic interaction between the BaO//CeO₂ electrode and the gel electrolyte, a pre-conditioning protocol is employed immediately prior to electrolyte application. The BaO//CeO₂-coated substrate is first pre-baked in a forced-convection oven at 373 K for 15 minutes. This step serves to remove residual surface moisture, elevate the substrate temperature for enhanced gel adhesion, and partially activate surface functionalities for better gel-polymer interaction. During this thermal pre-treatment, the substrate is clamped onto a thermally conductive aluminum block to ensure uniform heat distribution across its surface. The thermal conduction from the aluminum block helps eliminate temperature gradients that could lead to non-uniform wetting or premature gel solidification during subsequent processing.
Immediately after removal from the oven, and within a critical 60-second window to preserve thermal momentum, the gel electrolyte is applied. Using a calibrated micropipette, the gel is dispensed in a controlled volume, starting from the center and gradually extending outward in a circular spiral pattern. Simultaneously, the substrate is rotated at a low speed of 10 rpm. This controlled rotation promotes centrifugal spreading of the gel, ensuring an even film and eliminating edge pooling or gel trapping at the periphery. This method of dynamic application results in a homogeneously distributed layer with minimal thickness variation, which is essential for maintaining consistent ion transport and electrochemical response across the device area.
After the assembly of the gel layer over the electrode, a thermal conditioning step is performed to further improve the interface compatibility. This is achieved using an infrared (IR) lamp positioned 10 cm above the device, delivering mild radiant heat for 10 minutes. The lamp operation is governed by a digital timer, and the device surface temperature is closely monitored in real time using a non-contact infrared thermometer. The temperature is carefully maintained in the range of 308-313 K to facilitate softening of the gel electrolyte, allowing deeper molecular interpenetration at the electrode interface. This controlled softening improves adhesion and conformal contact without inducing degradation or premature crosslinking of the polymer matrix, preserving the gel's electrochemical functionality.
To initialize the device under controlled electrochemical stress, the assembled supercapacitor is subjected to an initial charging protocol using a programmable source meter. The voltage is gradually increased from 0 to 1.5 V in discrete steps of 0.1 V, with each voltage level held for 60 seconds under open-circuit conditions. This stepwise voltage ramp ensures a progressive electrochemical alignment of the internal components and allows early-stage ionic rearrangement within the gel electrolyte. During this initial formation process, the current response is recorded every 0.5 seconds using a 24-bit resolution data acquisition system, providing high-fidelity insight into the dynamic charge behavior and identifying any anomalies in leakage current, polarization, or ion migration patterns.
This embodiment establishes a thermally and electrochemically optimized interface between the BaO//CeO₂ electrode and the gel electrolyte, facilitating reliable device performance and stable long-term operation. The meticulous combination of pre-heating, real-time application, soft activation, and controlled voltage initiation underscores the technical efficacy and reproducibility required for high-performance solid-state asymmetric supercapacitor devices.
In an embodiment, during the preparation of the AC electrode slurry, an intermediate film-drying stage is introduced immediately after doctor blade application but prior to final heat treatment, wherein the wet-coated substrate is placed in a humidity-controlled chamber at 50%±2% relative humidity and 303 K for a period of exactly 25 minutes, and wherein during this period, the surface of the wet film is intermittently scanned using a laser reflectometer every 5 minutes to detect micro-gloss changes that indicate surface skin formation, wherein this partial drying stage is used to initiate controlled solvent evaporation at the top interface while preserving sub-surface wetness, thereby enabling differential densification upon subsequent thermal drying, wherein after this intermediate drying, the film is directly transferred for final curing in a staged temperature profile to preserve the stratified microstructure of the electrode, and wherein the AC-PVA slurry is deposited on the substrate using a dual-pass doctor blade method involving two sequential coatings, wherein the first pass is conducted using a blade gap of 100 microns at a draw speed of 8 mm/s, and the second pass is conducted after a 10-minute delay using a blade gap of 80 microns at a draw speed of 5 mm/s, wherein the delay period between passes is utilized to initiate partial gelation of the base layer, creating a soft-set interface for the second pass, wherein both coatings are applied along perpendicular directions with respect to each other to produce a crisscross grain orientation, and wherein this cross-pattern coating geometry is further stabilized by immediate exposure to a low-speed air stream (0.5 m/s) directed at 45 degrees relative to the substrate surface for 5 minutes to reduce edge sagging and promote uniform lateral diffusion of solvent across both coating layers.
In one embodiment, the preparation of the activated carbon (AC) electrode slurry is refined through a multi-stage coating and drying protocol specifically designed to optimize film microstructure, interfacial cohesion, and electrochemical uniformity. After preparing the homogenous AC-PVA slurry, the film is deposited onto the substrate using a dual-pass doctor blade technique. In the first pass, the doctor blade is set to a 100-micron gap and drawn across the substrate at a controlled speed of 8 mm/s, laying down a base layer with consistent thickness and particle dispersion. A precisely timed 10-minute delay follows this pass, during which partial gelation of the initial layer occurs. This partial setting process creates a soft-set interface, which improves adhesion and integration with the second layer, preventing interfacial slippage and enhancing mechanical robustness.
The second coating pass is applied perpendicularly to the first, using a slightly narrower blade gap of 80 microns and a slower draw speed of 5 mm/s. This perpendicular layering establishes a crisscross grain orientation that enhances mechanical interlocking and directional isotropy in the final electrode film, improving both mechanical strength and ionic transport properties. Immediately after the second pass, the freshly coated film is exposed to a low-speed, angled air stream (0.5 m/s at 45 degrees to the substrate) for 5 minutes. This directional airflow moderates solvent evaporation along the edges and across the surface, reducing the risk of edge sagging or bubble entrapment, and promoting even lateral diffusion of the remaining solvent.
Following the coating step, but before final thermal curing, an intermediate film-drying stage is implemented. The coated substrate is placed in a humidity-controlled chamber maintained at 50%±2% relative humidity and a stable temperature of 303 K for exactly 25 minutes. This environment is optimized to encourage partial evaporation of the solvent from the top surface, resulting in the formation of a thin “skin” layer. During this period, the surface is monitored every 5 minutes using a laser reflectometer to detect micro-gloss changes that signal the onset and progression of surface skin formation. The development of this semi-dried skin initiates stratified drying, wherein the top interface begins to solidify while the lower portion of the film retains moisture. This differential drying profile is critical to achieving a densified upper layer while preserving internal flexibility and ionic mobility in the sub-surface region.
After the intermediate drying step, the film is immediately transferred to the final curing stage without delay to preserve the partially stratified structure. The curing is conducted using a programmed thermal ramp, allowing solvent removal to proceed from the top down, thus locking in the layered microstructure. This method not only improves the film's mechanical and electrochemical stability but also minimizes internal stresses and shrinkage-induced cracking.

### Materials

Cerium (III) nitrate (Ce(NO₃)_{3.6}H₂O) (99% extra pure), barium nitrate (Ba(NO₃)₂) (99% extra pure), Sodium hydroxide pallets (NaOH) (98% extra pure), potassium hydroxide [KOH], sulphuric acid (H₂SO₄), acetone, and polyvinyl alcohol (PVA). All chemicals were acquired from Merck Private Ltd and used without using extra purification. SS was used as a conducting substrate.

### Synthesis of Thin Films

The synthesis of barium oxide (BaO) and cerium oxide (CeO₂) thin films was accomplished through a one-step SILAR technique, which allows for precise control over a deposition process. The fabrication of BaO thin films, a series of beakers containing different solutions were prepared: the first beaker contained 0.5 M barium nitrate Ba(NO₃)₂, the second contained distilled water (DW), the third had a 1 M sodium hydroxide (NaOH) solution, and the fourth contained additional distilled water. The substrate was sequentially dipped into these solutions, starting with the barium nitrate solution to simplify a adsorption of barium ions onto the SS substrate surface. The substrate was then immersed in distilled water to rinse off excess ions, followed by dipping into the NaOH solution to promote the formation of barium hydroxide. This method was repetitive for a total of 80 cycles to achieve a desired film thickness and uniformity. The films were subsequently rinsed in distilled water to remove any remaining reactants, then dried at an elevated temperature of 573 K for 1 hour, the BaO films were ready for further characterization.

In a similar manner, CeO₂ thin films were synthesized using 0.5 M Ce(NO₃)_{3.6}H₂O as the precursor solution. The same method was applied, where the substrate was dipped into the cerium nitrate solution to allow cerium ions to adsorb onto the substrate, followed by rinsing in distilled water and immersing in the sodium hydroxide solution to facilitate the formation of cerium hydroxide. This sequence was also repeated for 80 cycles, ensuring the formation of a consistent and homogenous thin film. After rinsing and drying at 573 K for 1 hour, the CeO₂ films were ready for further characterization.

To synthesize the barium oxide-cerium oxide (BaO//CeO₂) thin films, a mixed precursor solution was prepared, comprising 50% of 0.5 M barium nitrate and 50% of 0.5 M cerium(III) nitrate. The procedure followed the same sequential dipping protocol: the substrate was first immersed in the combined barium and cerium nitrate solution to allow for co-adsorption of both ions, then rinsed in DW, followed by dipping in 1 M NaOH to facilitate a synthesis of the barium-cerium hydroxide composite film. Each step was carefully timed, with a dipping duration of 60 seconds and rinsing for 20 seconds, repeated for a total of 80 cycles. Finally, the resulting composite thin films were dried at 573 K for 1 hour to ensure optimal crystallization and structural stability, yielding high-performance asymmetric supercapacitor BaO//CeO₂ electrodes.

### Synthesis of PVA-KOH Solid State Electrolyte

Synthesize an alkaline gel polymer electrolyte separator, 4-5 grams of potassium hydroxide (KOH) as well 3-4 grams of polyvinyl alcohol (PVA) were utilized. Initially, 3-4 grams of PVA were dissolved in 40-50 milliliters of DW, with the solution heated to around 348-353 K under continuous stirring to form a thick, clear gel. After cooling to ambient temperature, 10-15 milliliters of 1 M KOH solution were slowly introduced, followed by continuous mixing for 6 to 7 hours to ensure complete incorporation. This process resulted in a transparent, adhesive gel-like solution, which was carefully transferred to a Petri dish and left to dry naturally at room temperature. As it dried, a flexible and uniform alkaline gel polymer electrolyte separator layer formed, exhibiting the appropriate ionic conductivity and adhesion for use within a solid-state device. This method of synthesis provided a robust, conductive gel electrolyte capable of functioning efficiently as both electrolyte and separator within the assembled supercapacitor device.

### Synthesis of Activated Carbon (AC) Electrode

The preparation of AC electrode, a polyvinyl alcohol (PVA) solution was initially made by dissolving 1 gram of PVA in 10-15 milliliters of distilled water. This mixture was continuously stirred and heated to a temperature of approximately 343-353 K for 2 to 3 hours to achieve complete dissolution. Once fully dissolved, activated carbon (AC) was incorporated into the PVA solution, and the combination was further stirred for an additional 2 hours, maintaining the same temperature range. The resulting PVA-AC mixture formed a uniform slurry, which was subsequently placed in a desiccator to dry. This slurry was then evenly spread onto a thoroughly cleaned stainless steel (SS) substrate, sized roughly 15 cm by 20 cm, using a doctor blade to achieve a thin, consistent film. A coated electrode samples were first dried at ambient temperature for about 4 hours, followed by heat treatment in a muffle furnace at 353 K for an additional 6 to 7 hours, ensuring complete adherence and formation of the AC electrode layer on the substrate. This fabrication process yielded a robust, homogeneous AC electrode suitable for further electrochemical applications.

Fabrication of BaO//CeO_{2∥}1M PVA-KOH_{∥}AC Asymmetric Devices

The fabrication of the BaO//CeO_{2∥}1M PVA-KOH_{∥}AC device was carried out using a layered assembly approach. First, BaO and CeO₂ thin films were synthesized as the positive electrode using a SILAR method, which ensured uniform deposition and strong adhesion to the conductive substrate. Concurrently, AC was used as the negative electrode because of its high surface area and established electrochemical durability. The assembly of the device was performed by layering the BaO//CeO₂ positive electrode as well the AC negative electrode with a solid-state PVA-KOH gel electrolyte sandwiched in between. This configuration facilitated ion transport while physically isolating the electrodes, preventing short circuits. Once aligned, the layers were pressed together to ensure good contact between electrodes and the electrolyte layer, thereby enhancing ionic and electronic pathways. The completed ASSD was then allowed to stabilize under ambient conditions before electrochemical testing, which was essential to confirm the structural integrity and readiness of the device for subsequent performance evaluations.

### Physical Measurements

### Experiment Procedures for Supercapacitors Properties Measurements

The electrochemical properties of BaO//CeO₂ thin film electrodes were assessed through CV, GCD, and EIS. This analysis employed a 3-electrode setup in a 1 M KOH electrolyte. Here, a flexible BaO//CeO₂ nanocomposite thin films acted as a working electrode, with a platinum electrode as well an Ag/AgCl electrode functioning as the counter and reference electrodes, respectively. The CV measurements were conducted at multiple sweep rates within a potential range from −1.29 to 0.38 V. GCD evaluations were completed at various current densities, covering the same potential limits. For the EIS test, an AC signal of 10 mV was applied at a bias of 0.4 V, spanning a frequency ranging from 100 Hz to 1 MHz.

$$C {s}_{( C V )} = \frac{1}{m v ( {v}_{f} - {v}_{i} )} {\int }_{{v}_{i}}^{{v}_{f}} I ( V ) dv \qquad ( 1 )$$

$$SE = \frac{0.5 \times C {s}_{( G C D )} \times {( {v}_{f} - {v}_{i} )}^{2}}{3.6} \qquad ( 2 )$$

$$SP = \frac{3600 \times S E}{Δ t} \qquad ( 3 )$$

Where, “Cs_{(cv)}” specific capacitance in F/g using CV plots, “(V_{f}-Vᵢ)” potential window, ‘m’ active mass on electrode, ‘v’ sweep rate in mV/s, “∫ᵥ_{ᵢ}^{v}^{_{f}}” integral area under of CV curve, “SE” specific energy in Wh/kg, “SP” specific power in W/kg, “V” applied voltage in volt, “I(V)” current in mA.

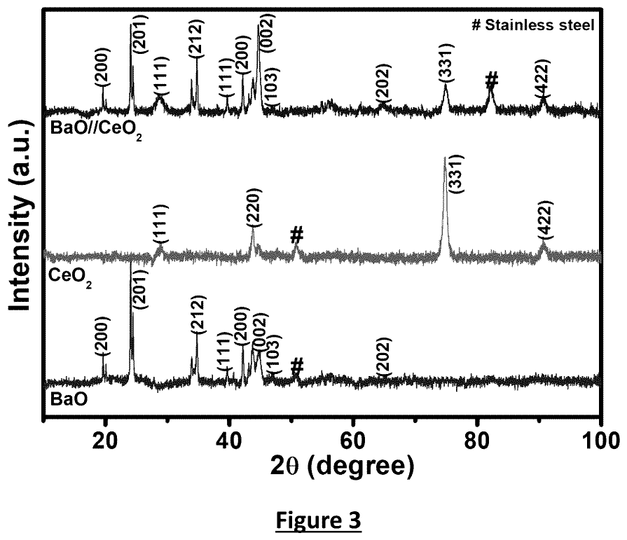

FIG. 3 illustrates a X-ray diffraction (XRD) patterns of the synthesized BaO, CeO₂, and BaO//CeO₂ thin film.

### XRD Analysis

In the X-ray diffraction (XRD) patterns of a synthesized BaO, CeO₂, and BaO//CeO₂ thin films using the SILAR method, distinct peaks confirm the formation of respective crystal structures with variations in crystallite sizes and shifts in peak positions in the composite material. The BaO sample exhibited peaks at 19.7°, 24.1°, 34.7°, 39.6°, 42.1°, 44.9°, 46.9°, and 64.5°, corresponding to the (200), (201), (212), (111), (200), (002), (103), and (202) planes, respectively, as indexed by JCPDS card No. 26-0178. These peaks indicate the tetragonal phase of BaO, with a calculated crystallite size of approximately 35 nm. The CeO₂ sample, the XRD pattern showed intense and sharp peaks at 28.5°, 43.5°, 75.1°, and 90.8°, corresponding to the (111), (220), (331), and (422) planes, as per JCPDS card No. 34-0394. These peaks confirm the formation of CeO₂ in a cubic structure, with an estimated crystallite size of around 29 nm. The well-defined and fine peaks indicate a higher degree of crystallinity in both individual BaO and CeO₂ phases.

The BaO//CeO₂ composite, the XRD pattern shows a combination of peaks from both BaO and CeO₂, with notable shifts in peak positions, particularly at 19.5°, 24.1°, 28.7°, 34.7°, 39.6°, 42.1°, 44.7°, 46.9°, 64.9°, 75.1°, and 90.8°, which correspond to the (200), (201), (111), (212), (111), (200), (002), (103), (202), (331), and (422) planes, respectively. These shifts suggest interfacial strain and lattice distortion caused by the incorporation of CeO₂ into the BaO matrix, resulting from differences in ionic radii and lattice structures of the two phases. The composite also exhibits broader peaks, which can be attributed to smaller crystallite sizes, calculated to be approximately 17 nm. This size reduction is likely due to increased strain and structural interaction at the BaO//CeO₂ interface, affecting lattice parameters and causing peak shifts. The observed peak shifts and broadening in the composite material reflect the impact of lattice strain and interfacial effects of the BaO//CeO₂ composite material.

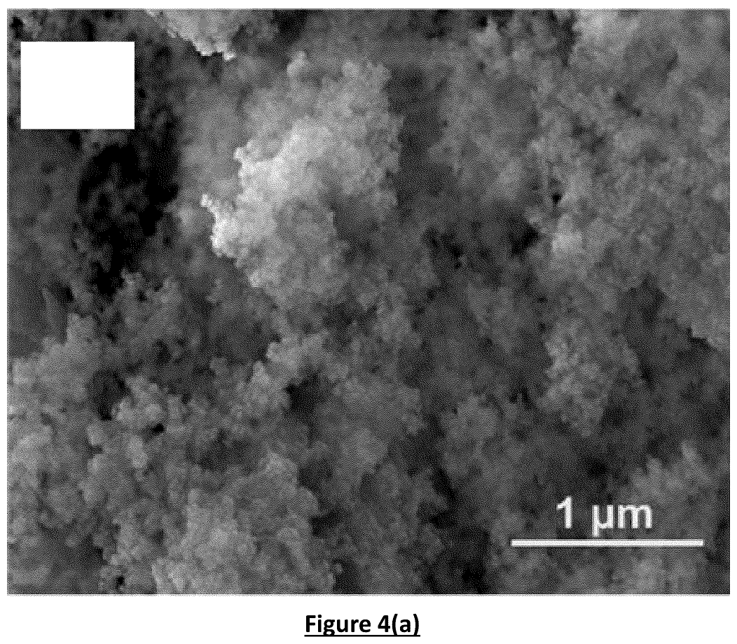

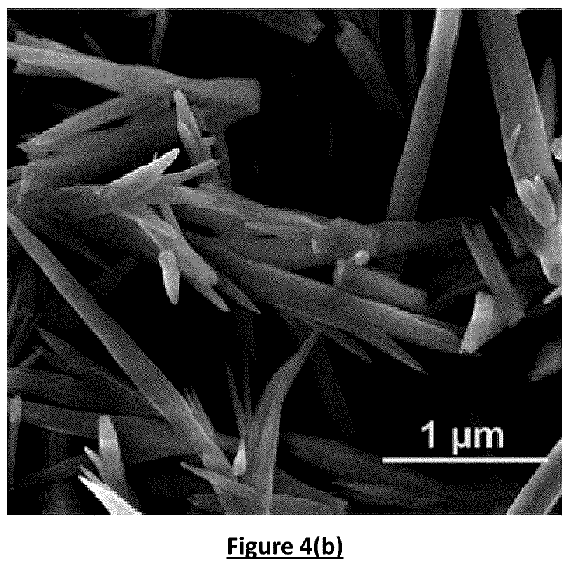

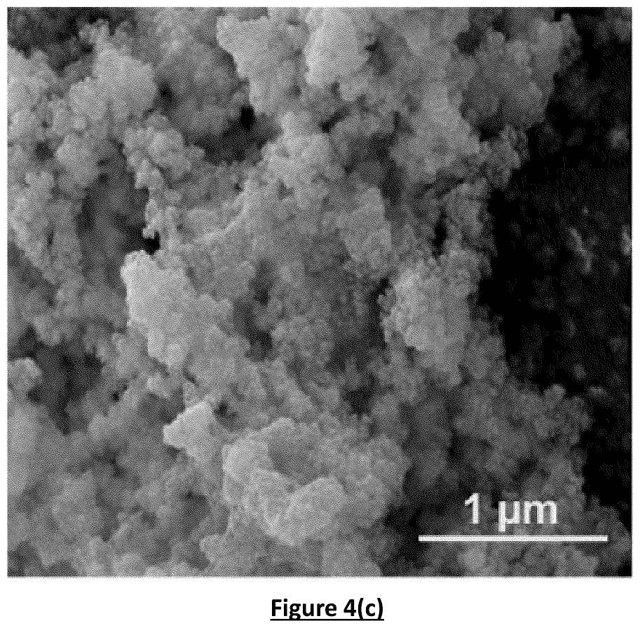

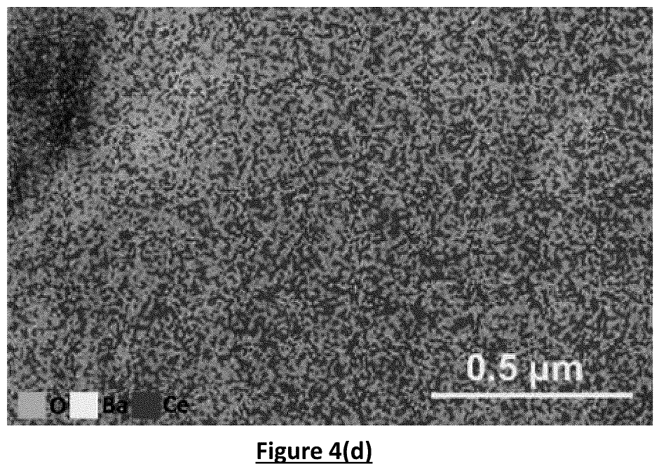

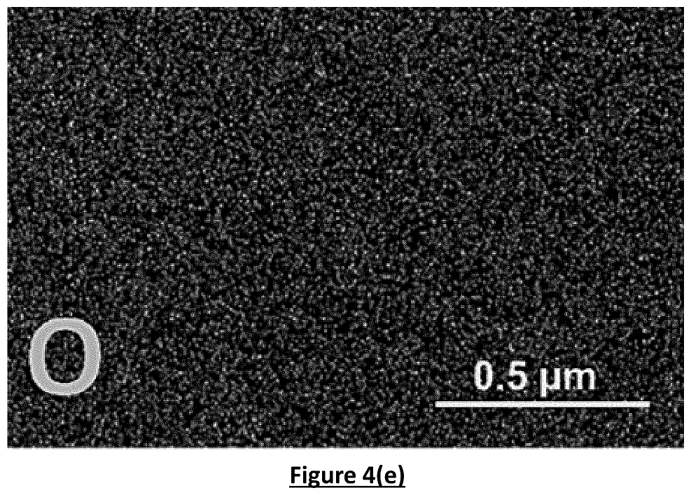

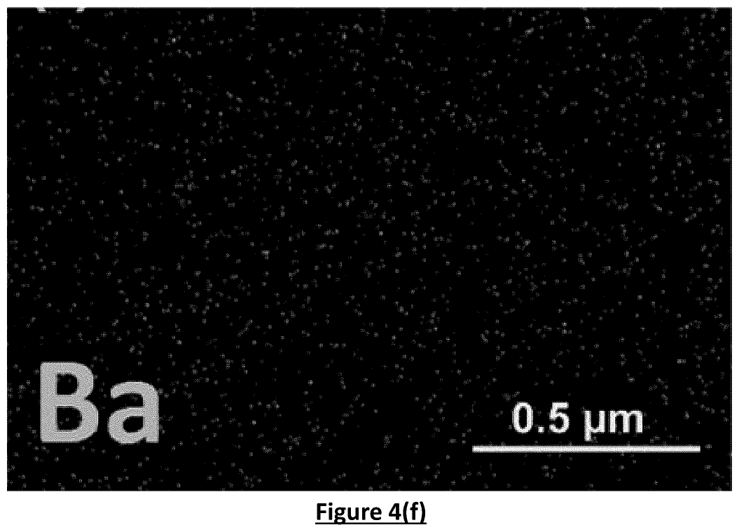

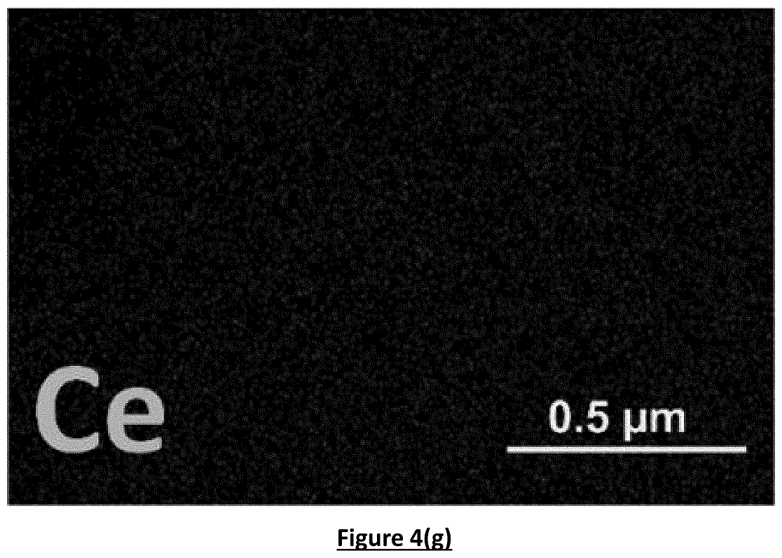

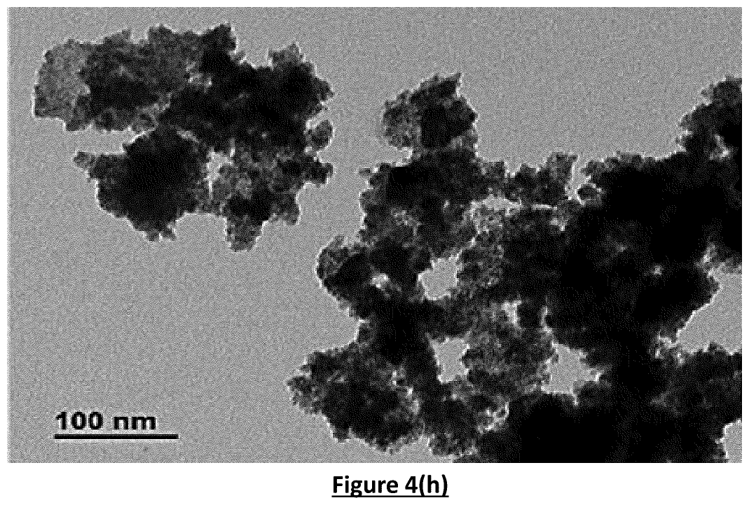

FIG. 4(a) illustrates a FE-SEM images at 1 μm of BaO//CeO₂;

FIG. 4(b) illustrates a FE-SEM images at 1 μm of BaO;

FIG. 4(c) illustrates a FE-SEM images at 1 μm of CeO₂;

FIG. 4(d) illustrates elemental mapping images of BaO//CeO₂ thin film;

FIG. 4(e) illustrates elemental mapping images of O;

FIG. 4(f) illustrates elemental mapping images of BaO;

FIG. 4(g) illustrates elemental mapping images of Ce;

FIG. 4(h) illustrates TEM image of BaO//CeO₂ thin film;

### Morphological Analysis

The field emission scanning electron microscopy (FE-SEM) images of a BaO//CeO₂, BaO, and CeO₂ thin films reveal significant morphological differences among the samples. The BaO//CeO₂ composite shown in FIG. 4(a) displays a densely packed, porous structure with coral-like aggregates. The BaO sample FIG. 4(b) shows rod-like structures that form a well-aligned, highly ordered array. This morphology suggests a high surface area, which can improve the electrochemical performance by providing more active sites. In contrast, the CeO₂ sample FIG. 4(c) exhibits a more granular, porous structure, which is beneficial for ion diffusion and charge storage. The distinct morphologies of BaO and CeO₂ contribute unique properties to the composite material, resulting in an enhanced structural network in the BaO//CeO₂ thin film.

Elemental mapping images of a BaO//CeO₂ composite, revealed in FIG. 4(d-g), confirm the homogeneous distribution of elements throughout the composite. The oxygen (O) elemental map FIG. 4(e) shows a uniform spread of oxygen, which is expected given the oxide nature of both BaO and CeO₂ . The barium (Ba) map FIG. 4(f) indicates a dispersed presence of Ba within the composite matrix, primarily from the BaO component. The cerium (Ce) map (FIG. 4(g)) similarly displays a consistent distribution, confirming that CeO₂ is well-integrated with BaO at the nanoscale. The elemental mapping verifies that Ba and Ce are uniformly embedded in the thin film, which is crucial for achieving uniform electrochemical activity across the electrode surface. This homogeneous distribution of elements in the BaO//CeO₂ thin film supports effective ion intercalation and charge storage, making it a suitable candidate for high-performance supercapacitors.

Transmission electron microscopy (TEM) image of a BaO//CeO₂ thin film FIG. 4(h) provides further insight into the nanoscale structure and confirms the composite's morphology observed in the FE-SEM. The TEM image reveals aggregated nanoparticles with an average size that aligns with the crystallite sizes calculated from XRD, approximately 17 nm. These nanoparticles form a continuous, porous network, which can facilitate rapid ion transport and electron mobility, essential for supercapacitive performance. The small particle size and porous structure contribute to a high surface area, enhancing the electrochemical capacity of the BaO//CeO₂ electrode. The FE-SEM, elemental mapping, and TEM results collectively demonstrate that the BaO//CeO₂ composite thin film possesses a well-integrated, high-surface-area structure, making it promising for energy storage applications.

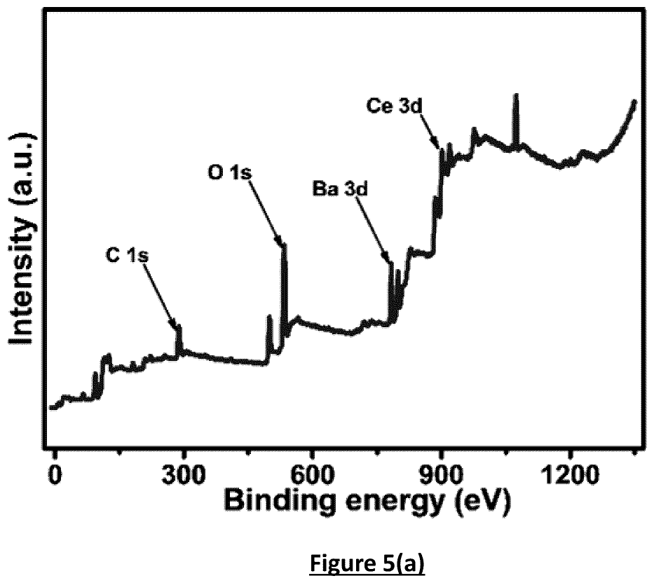

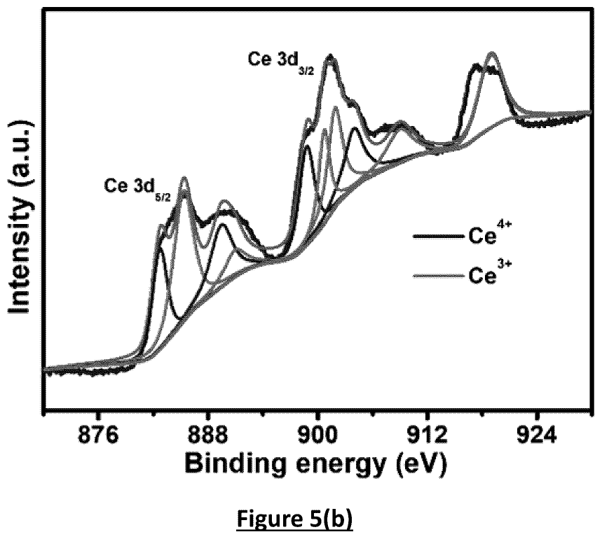

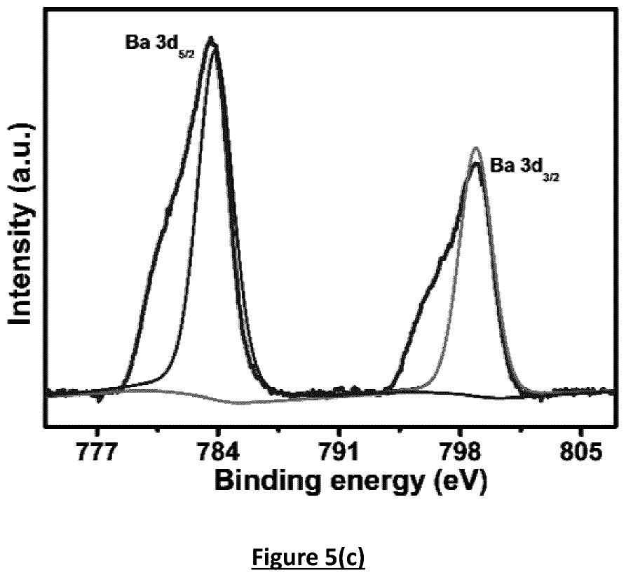

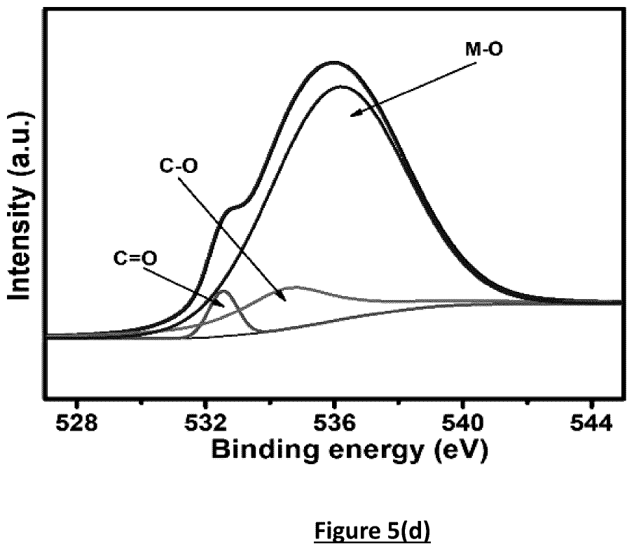

FIG. 5(a) illustrates Survey spectrum of BaO//CeO₂ thin film, showing key peaks corresponding to cerium (Ce 3 d), barium (Ba 3 d), oxygen (O 1 s), and carbon (C 1 s).

FIG. 5(b) illustrates deconvoluted XPS spectrum of Ce 3 d.

FIG. 5(c) illustrates deconvoluted XPS spectrum of Ba 3 d.

FIG. 5(d) illustrates deconvoluted XPS spectrum of O 1 s.

### XPS Analysis

The X-ray photoelectron spectroscopy (XPS) examination of a BaO//CeO₂ thin film electrode reveals the elemental composition as well oxidation states of barium, cerium, as well oxygen within a composite, confirming the successful formation of the BaO//CeO₂ thin film. The survey spectrum FIG. 5(a) demonstrations a occurrence of characteristic peaks corresponding to Ce 3 d, Ba 3 d, O 1 s, and a small peak for C 1 s, which is likely due to adventitious carbon. These findings validate the existence of the core elements Ba and Ce in their respective oxide forms within the composite film, indicating effective synthesis through the SILAR method.

In a high-resolution Ce 3 d spectra FIG. 5(b), deconvolution reveals multiple peaks associated with the oxidation states Ce⁴⁺ and Ce³⁺. Peaks at approximately 882.5 eV and 916.5 eV correspond to Ce⁴⁺, though peaks at 885.1 eV as well 903.3 eV indicate the presence of Ce³⁺. This mixed-valence state of cerium is significant for supercapacitor applications, as it can enhance the redox activity and contribute to increased charge storage capabilities. Similarly, the Ba 3 d spectrum FIG. 5(c) shows peaks at around 780.1 eV as well 795.1 eV, attributed to Ba 3 d_{5/2} and Ba 3 d_{3/2,} correspondingly, confirming the oxidation state of Ba²⁺ in the BaO component. The distinct Ba²⁺ oxidation state, combined with Ce in both Ce³⁺ and Ce⁴⁺ states, suggests a stable composite structure suitable for enhanced electrochemical performance.

The O 1 s spectrum FIG. 5(d) displays deconvoluted peaks around 529.6 eV as well 531.4 eV, which are assigned to metal-oxygen (M—O) bonds and surface oxygen species, respectively. The peak at 529.6 eV corresponds to a lattice oxygen in BaO and CeO₂, while a peak at 531.4 eV can be attributed to chemisorbed oxygen species or hydroxyl groups. The presence of these oxygen species contributes to the pseudocapacitive behavior by promoting surface redox reactions, further enhancing the device's charge storage capacity. The XPS analysis confirms the successful synthesis of a BaO//CeO₂ thin film with well-defined oxidation states, which is promising for applications in supercapacitors due to the enhanced redox activity and stable composite structure.

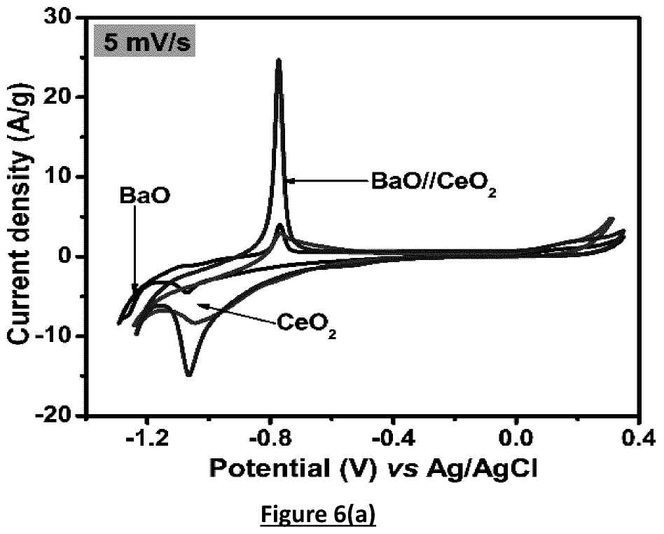

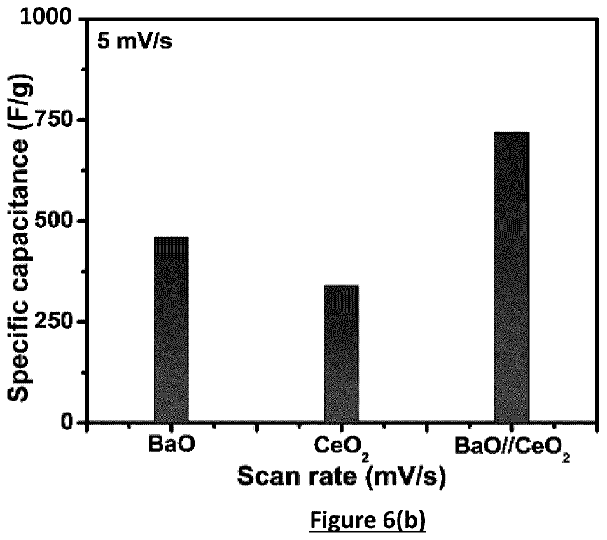

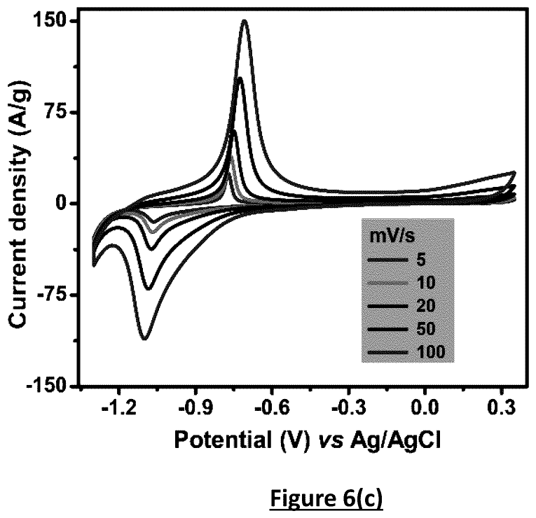

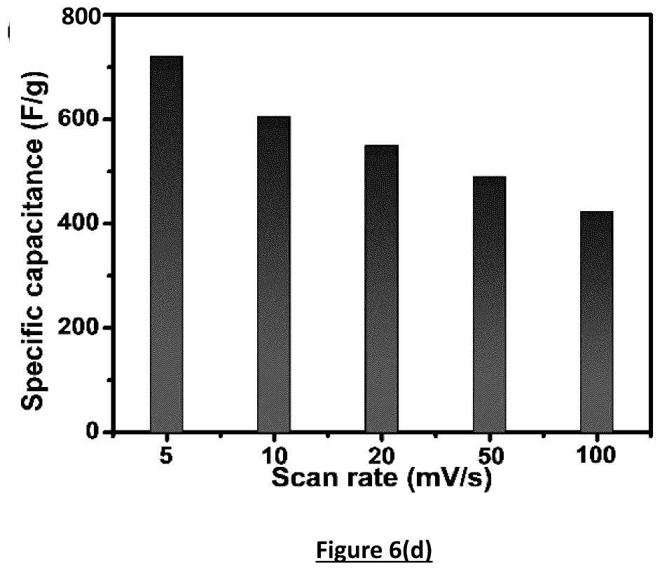

FIG. 6(a) illustrates cyclic voltammetry (CV) curves of a BaO, CeO₂, and BaO//CeO₂ electrode at sweep rate of 5 mV/s.

FIG. 6(b) illustrates plot of specific capacitance in F/g versus sweep rate in mV/s of BaO, CeO₂, and BaO//CeO₂ electrode respectively.

FIG. 6(c) illustrates Cyclic voltammetry plots of the BaO//CeO₂ electrode at dissimilar sweep rates from 5-100 mV/s.

FIG. 6(d) plot of specific capacitance in F/g versus dissimilar sweep rates form 5-100 mV/s respectively of BaO//CeO₂ electrode.

### Electrochemical Studies

### Cyclic Voltammetry (CV) Analysis of BaO//CeO₂ Electrode

The cyclic voltammetry (CV) curves presented in FIG. 6 reveal key differences in the electrochemical behavior of BaO, CeO₂, and the BaO//CeO₂ electrodes. The CV curves of BaO and CeO₂ show distinct redox peaks, indicating faradaic charge storage, which is characteristic of supercapacitor materials with pseudocapacitive behavior. Notably, the BaO//CeO₂ electrode exhibits a significantly higher current density, with a prominent redox peak shift, especially around −0.9 V as well −0.6 V vs. Ag/AgCl. These shifts in peak positions suggest improved electron transfer kinetics and enhanced electrochemical activity when BaO and CeO₂ are combined as shown in FIG. 6(a). The synergistic effect in the composite results from the complementary redox activity of BaO and CeO₂, leading to a higher Cs of 720 F/g, as shown in FIG. 6(b), surpassing individual contributions of BaO of 460 F/g and CeO₂ of 340 F/g.

The Cs values of a BaO//CeO₂ electrode, calculated at numerous sweep rates shows in FIG. 6(c), demonstrate excellent rate capability. At lower scan rates, the electrode achieves a high Cs of 720 F/g, gradually decreasing to 422 F/g at 100 mV/s, likely due to limited diffusion of electrolyte ions at high sweep rates shows in FIG. 6(d). The SEM reveals that the BaO//CeO₂ electrode has a granular and porous morphology, which enhances its capacitive performance by increasing the electrode-electrolyte border as well facilitating ion transport within a structure. A porosity enables rapid charge-discharge cycling, which, combined with the synergistic effects of BaO and CeO₂, contributes to a superior electrochemical concert of a BaO//CeO2 composite as a auspicious material for supercapacitor device.

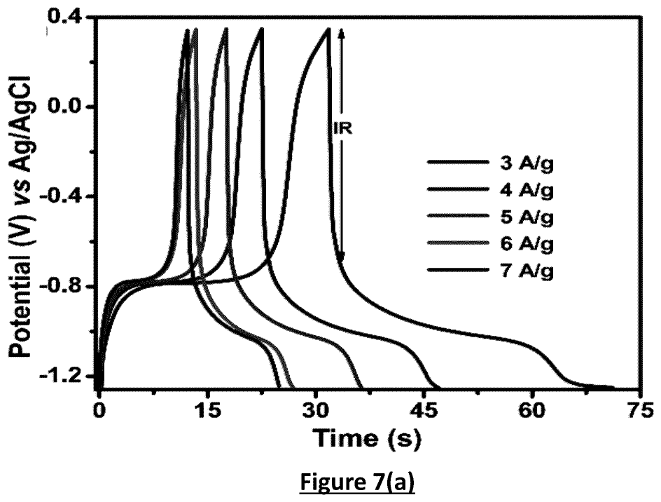

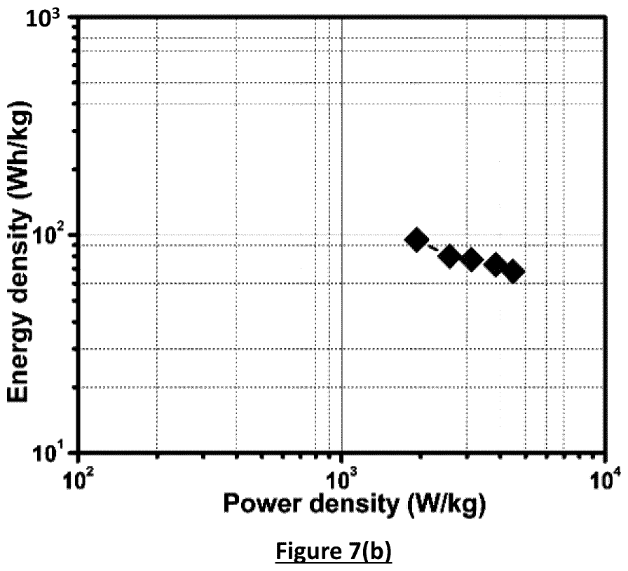

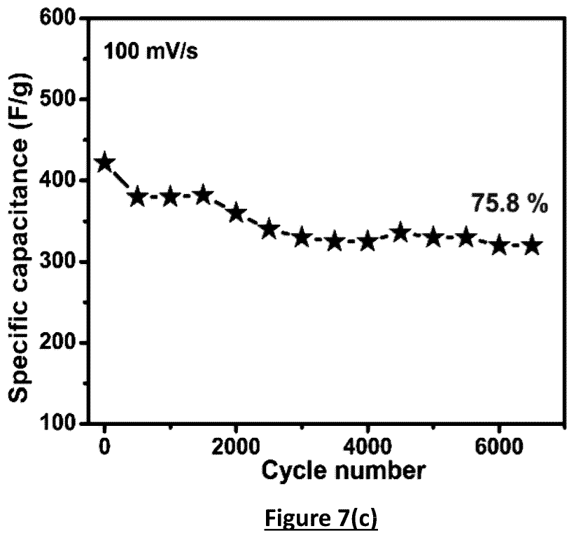

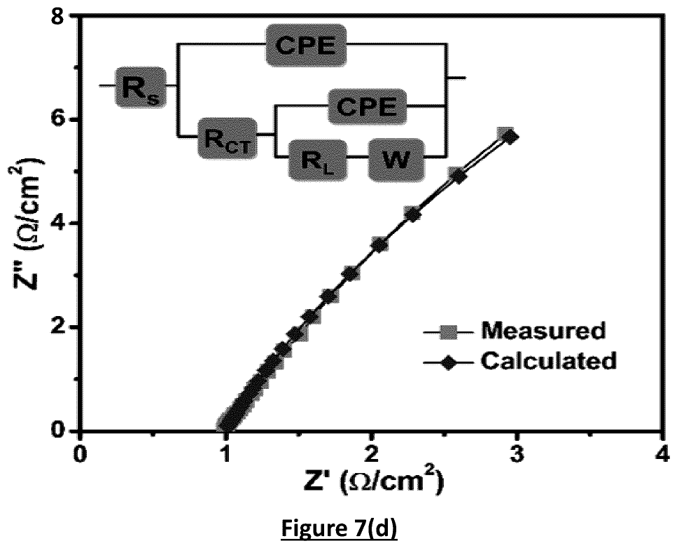

FIG. 7(a) illustrates Galvanostatic charge-discharge (GCD) plots of the BaO//CeO₂ electrode at current densities ranging of 3-7 A/g, illustrating the charge-discharge behaviour.

FIG. 7(b) illustrates regon plot of energy density (SE) in Wh/kg versus power density (SP) in W/kg of BaO//CeO2 electrode.

FIG. 7(c) illustrates cycling stability plot, indicating 75.8% capacitance holding after 6500 cycles for the BaO//CeO2 electrode, demonstrating excellent long-term electrochemical stability.

FIG. 7(d) illustrates Nyquist plot of the BaO//CeO2 electrode, showing the internal resistance (Ri) of 1 Ω, representing low resistive losses, inside an equivalent circuit model used to fit an experimental electrochemical impedance spectroscopy (EIS) data.

### Galvanostatic Charge-Discharge (GCD) Analysis of BaO//CeO₂ Electrode

The GCD curves of a BaO//CeO₂ electrode at numerous current densities, as depicted in FIG. 7(a), demonstrate the electrode efficient charge storage capabilities. At lower current densities, such as 3 A/g, a GCD profile illustrations a relatively extended discharge time, indicative of higher energy storage. As the current density rises from 3-7 A/g, the discharge times decrease, reflecting a natural reduction due to limited ion diffusion within the electrode structure at higher current densities. The minor voltage drops (IR drops) observed at the beginning of each discharge cycle are indicative of the electrode internal resistance, which remains manageable across the range of current densities tested. The corresponding ragone plot in FIG. 7(b) further characterizes the BaO//CeO2 electrode energy and power density performance. At a current density of 3 A/g, a electrode achieves a maximum SE of 95 Wh/kg, paired with a SP of 1930 W/kg. As a current density rises to 7 A/g, a energy density decreases to 68 Wh/kg although the power density escalates to 4490 W/kg, demonstrating the electrode' capability to deliver high power output with a moderate trade-off in energy density. This balance between energy and power densities highlights the BaO//CeO2 electrode potential for high-performance supercapacitor applications, where rapid charge-discharge cycles are essential.

### Stability Analysis of BaO//CeO₂ Nanocomposite Electrode

The cycling stability of the BaO//CeO₂ electrode, shown in FIG. 7(c), illustrates the electrode's robust performance over long-term use, with 75.8% capacitance holding after 6500 cycles at sweep rate of 100 mV/s. This high retention rate signifies excellent electrochemical stability, which is crucial for practical supercapacitor applications. The gradual decline in specific capacitance over time indicates some loss in active material accessibility or slight structural degradation under prolonged cycling. The electrode ability to retain a significant proportion of its initial capacitance even after thousands of cycles underscores its suitability for high-performance energy storage, where durability and long-term efficiency are essential. The superior stability of the BaO//CeO₂ electrode can be attributed to the structural and compositional advantages provided by the SILAR method, which likely enhances adhesion of the active materials to the substrate and promotes efficient electron transfer.

### Electrochemical Impedance Spectroscopy (EIS) Analysis of BaO//CeO₂ Nanocomposite Electrode

The Nyquist plot in FIG. 7(d) further provides insight into an electrochemical impedance characteristic of a BaO//CeO₂ electrode. A low internal resistance (Rs) of approximately 1 Ω, as derived from the intercept at the real axis, indicates minimal resistive losses, enhancing the electrode conductivity and facilitating rapid ion transport. The equivalent circuit model used to fit the EIS data, shown in an inset, includes components such as Rs, charge transfer resistance (R_{CT}) of 495.8 Ω, as well leakage resistance (R_{L}) of 0.7141 Ω, along with constant phase elements (CPE) that represent a non-ideal capacitive performance. A Warburg impedance (W), related to ion diffusion, also plays a role, reflecting the electrode's diffusion-controlled processes. The value of CPE=44.48×10−4 F, CPE=3.198×10−5 F, W=1.147 F. The close alignment between the measured and simulated Nyquist plots, obtained using ZsimpWin software, confirms the accuracy of the equivalent circuit in describing the electrode impedance behavior. These low resistive losses, coupled with stable capacitance retention, establish the BaO//CeO₂ electrode as a auspicious candidate for supercapacitor device.

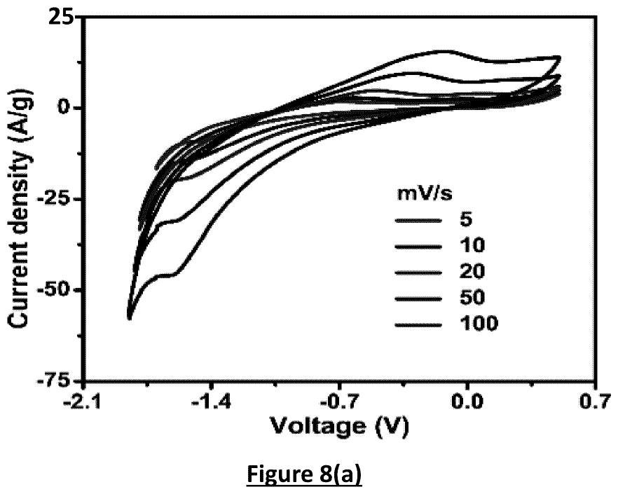

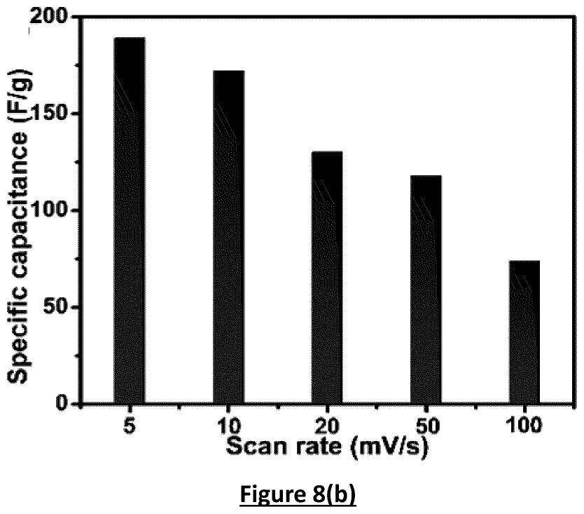

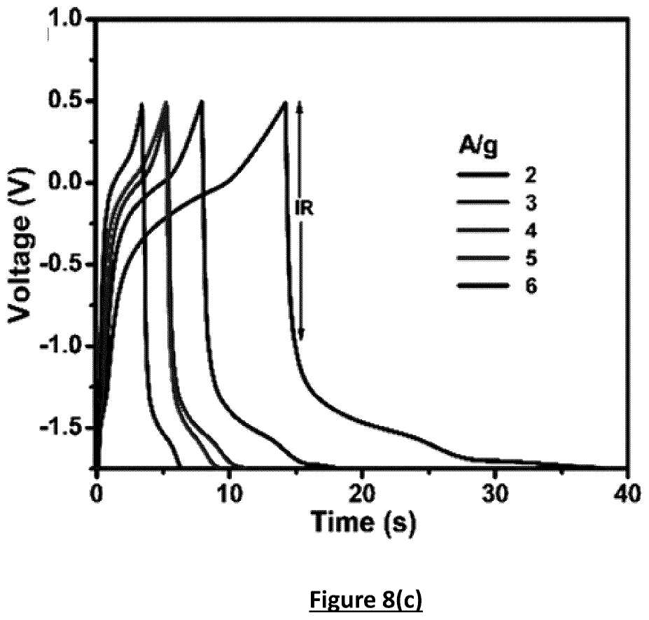

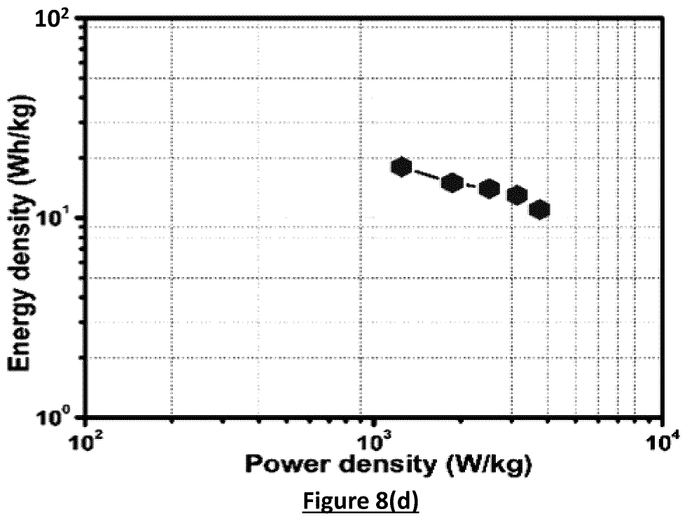

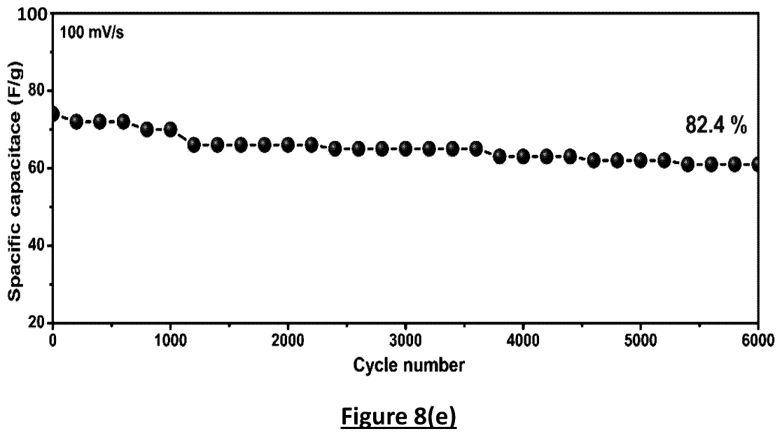

FIG. 8(a) illustrates The CV plots of the asymmetric supercapacitor at varying sweep rates of 5 to 100 mV/s, showing a device electrochemical behavior at dissimilar sweep rates.

FIG. 8(b) illustrates plot of Cs in F/g versus sweep rate of BaO//CeO_{2∥}1M PVA-KOH_{∥}AC asymmetric supercapacitor device (ASSD) device.

FIG. 8(c) illustrates the GCD plots of the ASSD device at current densities ranging of 2-6 A/g, illustrating the charge-discharge behaviour.

FIG. 8(d) illustrates regon plot of SE in Wh/kg versus SP in W/kg of ASSD device.

FIG. 8(e) illustrates cyclic stability test of the BaO//CeO_{2∥}1M PVA-KOH_{∥}AC asymmetric supercapacitor, measured at constant current density demonstrating excellent stability with 982.4% capacitance retention after 6000 cycles.

### Electrochemical Analysis of Asymmetric Solid-State (BaO//CeO_{2∥}1M PVA-KOH_{∥}AC) Device

The CV Analysis of BaO//CeO_{2∥}1M PVA-KOH_{∥}AC Device

The CV characteristics of a BaO//CeO₂ asymmetric supercapacitor device (ASSD) utilizing a 1M PVA-KOH electrolyte. FIG. 8(a) illustrates a CV curve for a device at varying sweep rates ranging of 5-100 mV/s, depicting the electrode electrochemical behavior and charge storage capacity at different scan rates. The CV profiles exhibit quasi-rectangular shapes with distinguishable redox peaks, which signify the device pseudo-capacitive nature where both electric double-layer capacitance as well faradaic processes contribute to energy storage.

At a lowest sweep rate of 5 mV/s, a device shows a substantial current response, attributed to a higher degree of active material utilization as well efficient ion diffusion into an electrode surface. This condition allows more accessible redox activity, resulting in a higher Cs of 189 F/g. As a scan rate is progressively increased to 10, 20, 50, and 100 mV/s, a noticeable reduction in current density and specific capacitance occurs. The values of specific capacitance decrease to 172, 130, 118, and 74 F/g at these respective scan rates, as shown in FIG. 8(b). This decrease is primarily due to diffusion limitations, where faster sweep rates hinder a penetration of ions into an electrode material, causing a lower degree of redox activity. Consequently, the charge storage transitions from being faradaic-dominated at lower scan rates to double-layer dominated at higher scan rates.

The BaO//CeO₂ ASSD high specific capacitance at low scan rates underscores its potential for applications requiring substantial energy storage with a slow charge/discharge cycle, ideal for low-power electronics. Furthermore, the CV curve analysis demonstrates that the electrode material exhibits good rate capability, retaining notable capacitance even at a high scan rate of 100 mV/s, though with a reduced magnitude. This rate-dependent capacitance behavior highlights the inherent trade-off in supercapacitors among energy density as well power density. The gradual shift from a pronounced rectangular shape at low scan rates to a more distorted shape at higher rates indicates the effect of ion diffusion kinetics and the electrode ability to accommodate fast charge-discharge cycles.

The GCD Analysis of BaO//CeO_{2∥}1M PVA-KOH_{∥}AC Device

The GCD behavior of a BaO//CeO_{2∥}1M PVA-KOH_{∥}AC asymmetric supercapacitor device (ASSD) to understand its charge storage performance and efficiency. FIG. 8(c) displays the GCD curves at numerous current densities, ranging of 2-6 A/g, providing a clear illustration of the electrode response to different charge-discharge rates. The GCD curves exhibit symmetrical triangular shapes, which indicate high coulombic efficiency and confirm the stable capacitive behavior of an electrode. A small IR drop is observed at a beginning of each discharge cycle, which is an indication of an internal resistance of a device as well its impact on energy efficiency.

At a low current density of 2 A/g, a device achieves longer discharge time, corresponding to a higher Cs, because of a greater utilization of the active material. As the current density increases to 3, 4, 5, and 6 A/g, a discharge time progressively decreases, which is expected due to the faster charging and discharging of the device. This trend reflects the rate-dependent behavior of the electrode; higher current densities reduce the accessible charge storage sites, thus leading to a lower effective capacitance. However, the device maintains considerable stability and charge-discharge symmetry across all tested current densities, which signifies its robustness for energy storage applications.

The Ragone plot in FIG. 8(d) further elucidates an energy as well power capabilities of the BaO//CeO₂ ASSD. Here, the SE, measured in Wh/kg, is plotted against the SP, in W/kg, across the same range of current densities. At a current density of 2 A/g, a device achieves a higher energy density of 18 Wh/kg, paired with moderate SP of 1250 W/kg, showcasing its potential for applications where energy retention is prioritized over quick discharge. As a current density rises to 3, 4, 5, and 6 A/g, the energy density gradually decreases to 15, 14, 13, and 11 Wh/kg, respectively, due to the faster discharge rates at these higher current densities. Concurrently, the power density increases to 1870, 2570, 3130, and 3760 W/kg, respectively, underscoring the device's capacity to deliver higher power outputs as needed. This inverse relationship between energy and power densities highlights the ASSD's versatility and adaptability to different operational demands, with the capability of balancing energy storage and rapid power delivery. The GCD analysis confirms that the BaO//CeO₂ ASSD exhibits excellent rate capability, maintaining both energy density as well power density at various current densities. This performance, combined with the stable charge-discharge characteristics and high energy-power density metrics, positions the BaO//CeO₂ thin film electrode, synthesized using the SILAR method, as a promising candidate for high-performance supercapacitor devices.

Stability Study of BaO//CeO_{2∥1}M PVA-KOH_{∥}AC device

The cyclic stability of the BaO//CeO₂ asymmetric supercapacitor device (ASSD) was evaluated to assess its long-term durability under repeated charge-discharge cycles. FIG. 8(e) illustrates the stability curve, where the specific capacitance retention was monitored over 6000 cycles at a constant sweep rate of 100 mV/s. This extended cycling test provides insight into the electrochemical robustness and structural integrity of the electrode material under sustained operation. The device demonstrates outstanding stability, retaining 82.4% of its initial Cs after 6000 cycles. This high retention rate indicates that the BaO//CeO₂ electrode material synthesized using the SILAR method exhibits minimal degradation over prolonged cycling, which is a serious requirement for practical supercapacitor applications. A gradual, slight decrease in capacitance observed throughout the cycling period may be attributed to the minor structural changes or electrode material dissolution over time, a common phenomenon in supercapacitors due to continuous ion insertion and extraction. The stability observed here is significantly higher than a conventional electrode material, indicating the superior electrochemical resilience of BaO//CeO2.

The exceptional cycling stability of this ASSD device, with a retention rate surpassing 80% even after thousands of cycles, underscores its potential for reliable energy storage in high-cycle applications. This performance can be attributed to the strong bonding and stable structural framework of BaO and CeO₂ thin films, which help resist mechanical stress and degradation over repeated cycles. The presence of the 1M PVA-KOH electrolyte, known for its compatibility with metal oxides, likely contributes to the stability of the electrode/electrolyte interface, enhancing long-term device performance.

The developed method synthesizes barium oxide-cerium oxide (BaO//CeO₂) thin film electrodes for asymmetric supercapacitors, comprising the use of a one-step Successive Ionic Layer Adsorption and Reaction (SILAR) process.

The SILAR process involves the sequential dipping of a substrate in a barium nitrate solution, distilled water, a sodium hydroxide solution, and again in distilled water, forming BaO.

The cerium oxide (CeO₂) thin films are synthesized using the SILAR method by dipping a substrate in a cerium nitrate solution, distilled water, sodium hydroxide, and distilled water.

The BaO//CeO₂ thin film electrode is synthesized by combining equal concentrations of barium nitrate and cerium nitrate in a single precursor solution for co-adsorption on the substrate.

The barium nitrate and cerium nitrate solutions are each used at a 0.5 M concentration to achieve balanced deposition.

Each SILAR cycle includes a 60-second dipping duration in the precursor solutions and a 20-second rinsing period in distilled water.

The SILAR cycle is repeated 80 times to obtain a uniform BaO//CeO₂ thin film.

The method further comprising heat treatment of the BaO//CeO₂ thin film electrode at 573 K for 1 hour to enhance crystallization and structural stability.

The resulting composite exhibits enhanced energy storage capabilities suitable for use in high-performance asymmetric supercapacitors.

The combination of BaO and CeO₂ provides high Cs and long cycling durability.

The BaO//CeO₂ thin film electrode is assembled in an asymmetric supercapacitor configuration with an activated carbon (AC) electrode as a negative electrode.

The 1M PVA-KOH gel electrolyte serves as both an electrolyte and separator between the BaO//CeO₂ positive electrode as well the AC negative electrode.

The BaO//CeO₂ thin film electrode provides a SP of 3760 W/kg and SE of 18 kW/kg that exceeds those of conventional metal oxide supercapacitors.

The BaO//CeO₂ electrode performance is characterized by specific capacitance values at various scan rates, demonstrating enhanced rate capability, highest Cs is 189 F/g at 5 mV/s.

The BaO//CeO₂ thin film electrode demonstrates high cycling durability with capacitance holding exceeding 75% after 6000 cycles.

The presence of both Ba²⁺ and Ce³⁺/Ce⁴⁺ ions contribute to enhanced redox activity and electrochemical performance.

The SILAR process produces a BaO//CeO₂ thin film with a densely packed, porous structure with coral-like aggregates morphology, as confirmed by FE-SEM imaging.

The BaO//CeO₂ thin film electrode, achieves a highest Cs of 720 F/g, providing enhanced energy storage capacity for use in high-performance asymmetric supercapacitor applications.

The BaO//CeO₂ thin film electrode demonstrates low internal resistance of 1 Ω and efficient ion transport as shown in electrochemical impedance spectroscopy (EIS).

The SE and SP values of a BaO//CeO₂ thin film electrode make it suitable for applications requiring both high SP of 4490 W/kg and high SE of 95 kW/kg.

The BaO//CeO₂ thin film electrode is synthesized by a one-step SILAR process, provides a scalable and cost-effective approach for manufacturing advanced supercapacitor materials, supporting renewable energy storage applications.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A process of fabricating an asymmetric supercapacitors device, comprising:
a) synthesizing a BaO and CeO₂ thin film as a first electrode using a one-step successive ionic layer adsorption and reaction (SILAR) method for uniform deposition and adhesion on a conductive substrate;
b) synthesizing an activated carbon (AC) electrode as a second electrode, and wherein the activated carbon (AC) electrode synthesis, comprising:
dissolving 1 gram of polyvinyl alcohol (PVA) in 10-15 milliliters of distilled water to form a solution;
heating the solution to a temperature of about 343-353 K under stirring for 2-3 hours to form a PVA solution;
adding activated carbon (AC) to the PVA solution;
stirring the mixture of PVA and AC for a period of about 2 hours at a temperature of about 343-353 K to form a uniform slurry;
placing the resulting PVA-AC slurry in a desiccator for drying;
applying the slurry to a substrate; and
drying the slurry on the substrate for formation of the AC electrode layer;
c) formulating a solid-state electrolyte layer comprising polyvinyl alcohol (PVA) and potassium hydroxide (KOH), wherein the solid-state electrolyte layer is formed as a gel;
d) assembling the device by layering the first electrode, the solid-state electrolyte layer, and the second electrode in a stacked configuration, wherein the assembled device is allowed to stabilize for a period of 12-24 hours at room temperature to ensure uniform distribution of the electrolyte and structural integrity; and
e) pressing the assembled layers together to enhance contact between electrodes and the electrolyte, wherein the SILAR process for synthesizing BaO and CeO₂ thin films includes multiple cycles of ion adsorption and reaction, followed by rinsing and annealing to enhance material uniformity and adhesion, wherein the pressing step is performed under a specific pressure range to ensure optimal contact between the layers without damaging the electrodes or electrolyte, wherein the first electrode is a positive electrode, wherein the second electrode is a negative electrode, wherein the preparation of the PVA-KOH gel electrolyte involves dissolving polyvinyl alcohol in water, mixing it with a potassium hydroxide solution, and allowing the mixture to form a gel under controlled temperature conditions, wherein said
said conductive substrate is selected from a group of stainless steel, glassy carbon, or fluorine-doped tin oxide (FTO); said first electrode comprising a thin film of BaO and CeO₂ is disposed on the conductive substrate; said second electrode comprising activated carbon (AC); and said solid-state electrolyte layer is disposed between the first and second electrodes, the electrolyte layer comprising polyvinyl alcohol (PVA) and potassium hydroxide (KOH) to facilitate ion transport and electrically isolate the electrodes to prevent short circuits, wherein the solid-state electrolyte layer is a gel electrolyte; and a current collector is in contact with each of the first and second electrodes, wherein said first electrode is a positive electrode and said second electrode is a negative electrode.

2. The process of claim 1, wherein the barium oxide-cerium oxide (BaO//CeO₂) composite thin films synthesis, comprising:
preparing a first solution as a mixed precursor solution comprising 50% of 0.5 M barium nitrate (Ba(NO₃)₂), and 50% of 0.5 M cerium nitrate (Ce(NO₃)₃·6H₂O);
preparing additional solutions, including:
a second solution comprising distilled water,
a third solution comprising 1 M sodium hydroxide (NaOH), and
a fourth solution comprising distilled water;
sequentially dipping a substrate into the prepared solutions, including:
immersing the substrate in the mixed precursor solution to adsorb barium and cerium ions onto the substrate surface,
rinsing the substrate in the second solution to remove excess ions,
immersing the substrate in the third solution to facilitate the formation of a barium-cerium hydroxide composite film, and
rinsing the substrate in the fourth solution;
repeating the sequential dipping process for 80 cycles, with each dipping step lasting 60 seconds and each rinsing step lasting 20 seconds, to achieve a desired film thickness and uniformity; and
drying the coated substrate at an elevated temperature of 573 K for 1 hour to ensure crystallization and structural stability, yielding BaO//CeO₂ composite thin films.

3. The process of claim 1, wherein the solid-state electrolyte formulation, comprising:
dissolving 3-4 grams of polyvinyl alcohol (PVA) in 40-50 milliliters of deionized water (DW) to form a solution;
heating the solution to a temperature of about 348-353 K under stirring to form a gel; cooling the gel to ambient temperature;
adding a 10-15 milliliters of 1 M potassium hydroxide (KOH) solution to the cooled gel; and
mixing the gel and KOH solution for a period of about 6-7 hours to ensure complete incorporation of KOH into the gel.

4. The process of claim 3, further comprises transferring the gel to a Petri dish and allowing the gel to dry naturally at room temperature to form a flexible and uniform solid-state electrolyte layer, wherein applying the slurry to the substrate comprises using a doctor blade to form a thin and consistent film, wherein the drying step comprises drying the slurry at ambient temperature for about 4 hours followed by heat treatment, and further comprising heat treating the coated substrate in a muffle furnace at a temperature of about 353 K for a period of about 6-7 hours.

5. The process of claim 2, wherein each of the 80 cycles of the successive ionic layer adsorption and reaction includes a precise substrate immersion protocol, wherein the substrate is initially held vertically in the barium nitrate and cerium nitrate mixed precursor solution for 60 seconds with no agitation, followed by manual angular tilting of the substrate at 30° increments in a clockwise rotation during each 10-second interval within the 60-second duration to facilitate directional ion anchoring across the surface topology, wherein the subsequent immersion in distilled water involves lateral oscillation of the substrate at a fixed amplitude of 5 mm and frequency of 2 Hz during the entire 20-second rinse to dislodge uncoordinated ions, wherein immersion into 1 M sodium hydroxide is conducted with real-time monitoring of pH at the substrate surface using a micro-electrode, and wherein a final rinse in distilled water is immediately performed under laminar flow conditions to prevent ion redistribution, and wherein each cycle is separated by a 10-second ambient exposure period with the substrate held in a dust-free acrylic enclosure to maintain reproducibility of surface hydration conditions across successive cycles.

6. The process of claim 3, wherein dissolution of 3-4 grams of polyvinyl alcohol in 40-50 milliliters of deionized water is performed inside a double-jacketed borosilicate glass reactor equipped with a temperature feedback loop, wherein heating is initiated using a water circulator set to ramp up the temperature at a constant rate of 1.5 K per minute until the solution reaches 348-353 K, wherein the stirring is executed using a four-blade PTFE impeller rotating at 90 rpm for a duration of precisely 1.5 hours before being reduced to 60 rpm for an additional hour to minimize foam formation and microbubble entrapment, wherein the resultant gel is transferred into a polypropylene beaker and allowed to cool passively on a vibration-damped granite surface at ambient conditions without application of forced convection, and wherein the potassium hydroxide solution is introduced using a microdialysis syringe pump at a volumetric flow rate of 0.25 mL per minute under continuous mechanical stirring at 50 rpm for the full 6-7 hour mixing duration, wherein the final mixture is sampled every hour for conductivity measurements using a calibrated four-point probe cell to verify progressive integration of ionic species into the polymer network without batch deviation.

7. The process of claim 1, wherein the assembly of the asymmetric supercapacitor device is performed inside a nitrogen-filled glovebox maintaining oxygen and moisture levels below 1 ppm, wherein the BaO//CeO₂ thin film-coated conductive substrate is first positioned on a glass alignment plate with laser-etched registration marks, and the PVA-KOH gel electrolyte is cast over it using a Teflon-coated applicator with a fixed height gap of 100 microns, wherein the AC electrode is aligned and placed over the gel-coated first electrode using an optical alignment jig with x-y micrometer screws enabling sub-millimeter accuracy, wherein the entire stacked structure is left undisturbed for 18 hours on a vibration-isolated surface maintained at 295-298 K in a dark enclosure to prevent thermal or photonic polymer relaxation, and wherein pressing is carried out using a hydraulic cold press at a controlled force of 8 N/cm² for 3 minutes using a pair of polished stainless-steel platens whose surfaces are cleaned with isopropanol prior to application, and wherein no post-pressing movement or re-alignment is permitted during the 30-minute post-press rest period to retain consistent interfacial bonding characteristics, and
wherein the solid-state electrolyte layer applied between the first and second electrodes is formed into a semi-dry film prior to stacking by spreading the gel over a non-stick PTFE-coated glass surface using a manual rolling bar adjusted to a fixed height of 200 microns and left undisturbed at 293 K for 8 hours, wherein the semi-dried film is then manually peeled and transferred to the BaO//CeO₂ electrode using stainless-steel tweezers under magnification to prevent film cracking or folding, and wherein the interface between the semi-dried electrolyte and both electrodes is further enhanced by applying a controlled rolling pressure of 1 N/cm² using a cylindrical Teflon roller over a 10-second pass, repeated three times from alternating directions.

8. The process of claim 1, wherein the preparation of the activated carbon electrode comprises selecting activated carbon particles with a surface area range of 1000-1200 m²/g and particle diameter distribution between 20-50 microns, wherein the AC is gradually added to the PVA solution over a period of 30 minutes using a powder funnel with magnetic vibration assistance to prevent clumping, wherein the PVA-AC mixture is stirred using a coaxial paddle blade at 343-353 K for 2 hours with interspersed 5-minute pauses every 30 minutes to allow thermal equilibration, wherein the slurry is poured into a PTFE-coated mold and stored in a vacuum desiccator maintained at −0.08 MPa for 12 hours to remove entrapped air, wherein the slurry is applied onto the substrate using a doctor blade with an adjustable micrometer-controlled gap of 150 microns at a draw speed of 10 mm/s, and wherein the drying step includes a two-stage thermal cycle: ambient air drying for 4 hours followed by heating in a muffle furnace at 353 K for 6.5 hours with a ramp rate of 1 K/min and intermediate hold at 333 K for 2 hours to facilitate gradual solvent release and crystallization of the film structure, and
wherein the activated carbon used in the AC electrode is pre-dried at 393 K in a vacuum oven for 6 hours prior to addition to the PVA solution to remove residual moisture, wherein the prepared AC-PVA slurry is continuously degassed during the 2-hour stirring phase using a diaphragm vacuum pump connected to a side-arm of the mixing chamber, wherein the doctor blade application is conducted in a cleanroom environment classified as ISO Class 7 to prevent airborne particulate inclusion in the wet film, and wherein the substrate upon which the slurry is coated is pre-heated to 323 K using a resistive heating plate to promote immediate solvent flashing at the substrate interface.

9. The process of claim 5, wherein the substrate used for BaO//CeO₂ film deposition is pre-treated by ultrasonication in a sequential solvent bath of acetone, ethanol, and deionized water, each for 15 minutes, followed by a drying step in a hot-air oven at 323 K for 30 minutes, wherein the substrate surface is then plasma-treated using low-pressure oxygen plasma at 100 W for 5 minutes to enhance surface hydrophilicity and electrostatic adsorption capacity, and wherein prior to each immersion cycle in the precursor solution, the substrate is held at a 10° inclination within the bath to initiate gravitational-driven ion distribution along the surface to create a slight compositional gradient across the substrate length.

10. The process of claim 6, wherein the gelled PVA-KOH electrolyte is subjected to centrifugation at 3000 rpm for 10 minutes at ambient temperature immediately after the 7-hour mixing cycle to remove macro-aggregates and inhomogeneous polymer clusters, wherein the supernatant gel is carefully decanted and cast into a sterile polypropylene Petri dish lined with a Teflon sheet, and wherein the gel is then allowed to stand in a low-humidity desiccation chamber for 24 hours without forced air exposure, under a silica-gel regulated environment to achieve gradual phase stabilization and uniform gel thickness with minimum internal strain.

11. The process of claim 1, wherein the annealing of the BaO//CeO₂ thin film following SILAR deposition is conducted in a programmable muffle furnace with a three-stage thermal ramp: initially increasing from room temperature to 473 K over 30 minutes, followed by a hold at 473 K for 15 minutes, then ramping to 573 K over another 30 minutes and holding for 1 hour, wherein the annealing chamber includes a sacrificial ceramic crucible loaded with activated alumina to capture residual nitrates and prevent re-adsorption on the film surface, and wherein the post-annealing cooling is conducted inside the furnace by passive cooling over 3 hours with the furnace door slightly ajar.

12. The process of claim 3, wherein the PVA-KOH gel is subjected to cross-linking stabilization by exposure to glutaraldehyde vapors in a sealed chamber for a period of 20 minutes at room temperature after initial gel formation and prior to device assembly, wherein the exposure is conducted using a desiccator-based vapor diffusion method with a 2% glutaraldehyde solution placed in a shallow dish under the gel-containing tray, and wherein the resulting cross-linked gel is verified by FTIR spectroscopy confirming the presence of C═N imine bonding peaks in the range of 1650-1700 cm⁻¹, indicating successful Schiff base formation between aldehyde groups and hydroxyl functionalities of the PVA, and wherein the PVA solution prior to gel formation is filtered through a 0.45-micron polypropylene filter to remove insoluble particulates, and wherein the KOH solution is pre-heated to 318 K before mixing to minimize abrupt thermal shocks during addition, wherein during the mixing stage, a rotating magnetic stir bar with a rare-earth magnet is used inside a low-friction PTFE-coated vessel to avoid ion contamination, and wherein a digital refractometer is used at 1-hour intervals during mixing to monitor real-time refractive index variation as an indirect measure of homogeneity in ion-polymer interaction; and
wherein after mixing the PVA and KOH to form the gel, the sample is subjected to a series of freeze-thaw cycles comprising three repetitions of freezing at −20° C. for 2 hours followed by thawing at 298 K for 1 hour, wherein the cycles are executed inside a programmable freezer-thaw chamber equipped with an internal temperature logger, and wherein the gel viscosity after the third cycle is measured using a rotational viscometer at a shear rate of 10 s⁻¹ to confirm that the thixotropic behavior remains within a pre-defined viscosity range of 1200-1500 cP.

13. The process of claim 2, wherein the precursor solution used for SILAR deposition is magnetically stirred at 200 rpm throughout the deposition process using an overhead stirrer to prevent ion settling, and wherein the concentration of barium and cerium nitrates is verified by UV-Vis spectroscopy every 10 cycles by sampling 1 mL of solution and comparing absorption peaks at 300-400 nm, and wherein any deviation beyond ±5% of absorbance is corrected by replenishing the solution with freshly prepared precursor maintaining the original molar concentration ratio, and wherein the pressing step involves placing the fully assembled device stack between two layers of soft silicone elastomer sheets with a Shore A hardness of 30 to distribute pressure evenly, and wherein a load cell is integrated into the hydraulic press mechanism to record real-time pressure data, wherein the pressing duration is precisely controlled by a timer-relay system and terminated automatically once the set force threshold of 8 N/cm² is maintained for a full 180 seconds, and wherein the assembly is then allowed to rest between the press platens for an additional 5 minutes without applied force to preserve interfacial conformation developed during pressing.

14. The process of claim 4, wherein the slurry-dried AC electrode on the substrate is first characterized using a laser profilometer to assess thickness uniformity across the surface area at 100-micron resolution, and wherein areas deviating by more than ±10 microns from the average thickness are excluded from further device assembly, and wherein the heat treatment in the muffle furnace is performed using a sintering program with a controlled rise of 2 K per minute, a hold at 353 K for 6.5 hours, and a natural cool-down in a closed furnace environment with no door opening until the internal temperature reaches below 323 K.

15. The process of claim 1, wherein prior to the device assembly, each electrode is weighed using an analytical balance with 0.01 mg sensitivity and the surface area is measured using a digital caliper, and wherein electrodes are selected for assembly only if the weight-to-area ratio for both electrodes falls within a range of 1.20-1.30 mg/cm² to maintain symmetrical energy distribution, and wherein after assembly and pressing, the final device is encapsulated in a non-conductive heat-shrink polymer sleeve under mild heating to provide mechanical protection without affecting electrochemical behaviour, and wherein the interfacial compatibility between the BaO//CeO₂ thin film and the solid-state electrolyte is enhanced by applying a plasma surface activation treatment on the dried thin film using a radiofrequency oxygen plasma source at 50 W power for 3 minutes immediately prior to electrolyte application, wherein this activation step is carried out inside a vacuum-compatible surface modification chamber equipped with a rotating sample stage set to 10 rpm, and wherein post-plasma treatment, the film is transferred directly to the assembly station without exposure to ambient air, using an inert atmosphere sealed transfer capsule to preserve the activated surface reactivity.

16. The process of claim 1, wherein the surface roughness of the dried BaO//CeO₂ thin film is characterized using atomic force microscopy (AFM) in tapping mode, and only films exhibiting a root mean square (RMS) roughness between 10 and 20 nanometers over a 10 μm×10 μm scan area are selected for device assembly, wherein the AFM measurements are conducted using a silicon nitride cantilever with a nominal tip radius of 8 nm, and wherein this roughness threshold is used to define optimal interfacial contact conditions between the electrode and the gel electrolyte to facilitate uniform ion migration pathways.

17. The process of claim 1, wherein during the mixing of activated carbon into the PVA solution, the electrical conductivity of the slurry is measured in real-time using a stainless-steel electrode pair inserted into the solution at a fixed separation of 10 mm, connected to a conductivity meter with a resolution of 0.1 μS/cm, and wherein the AC addition is paused intermittently every 5 minutes during the 30-minute dispersion process to allow for homogenization equilibration, and resumed only when the conductivity increase between two successive readings is less than 2%, thereby confirming stabilization of the particle-polymer ionic interface before further addition, wherein the final assembled supercapacitor device is subjected to a compression-relaxation fatigue test consisting of 100 manual pressing cycles applied using a 1 kg force across the surface in a custom-fabricated jig to simulate real-world mechanical stress, wherein the device is visually monitored under an optical microscope after every 25 cycles to detect delamination or cracking, and wherein devices that show surface microfractures or electrode gel separation exceeding 5 microns in width are excluded from electrochemical evaluation, and wherein the drying of the activated carbon electrode layer on the substrate includes a step of placing the wet-coated substrate over a vibrating hotplate set to 323 K and oscillating at 15 Hz with 1 mm vertical amplitude for the first 30 minutes, followed by transfer to a vacuum oven at 323 K for 6 hours with pressure maintained at −0.09 MPa, wherein the transition between steps is limited to less than 1 minute and conducted under a nitrogen environment to minimize water uptake from ambient air.

18. The process of claim 1, wherein the BaO//CeO₂-coated substrate is pre-baked in a forced-convection oven at 373 K for 15 minutes immediately prior to application of the gel electrolyte layer, wherein the substrate is clamped on a thermally conductive aluminum block during pre-baking to achieve uniform heating, and wherein the gel is applied within 60 seconds of substrate removal from the oven, using a calibrated micropipette in a circular pattern from center to edge while rotating the substrate at 10 rpm, promoting centrifugal spreading and eliminating gel trapping at the periphery, and wherein the gel electrolyte and the BaO//CeO₂ electrode interface is thermally conditioned by mild heating using an IR lamp at a distance of 10 cm for 10 minutes after stacking and before pressing, wherein the lamp is controlled using a digital timer and the surface temperature of the device is monitored by a non-contact IR thermometer, and wherein the temperature is maintained within the range of 308-313 K throughout the conditioning step, enhancing softening and molecular interpenetration at the interface without initiating premature degradation of the polymer matrix, and wherein the initial charging of the assembled device is performed using a programmable source meter that applies a stepwise voltage increase from 0 to 1.5 V in increments of 0.1 V, holding each step for 60 seconds under open-circuit conditions before proceeding, and wherein current response is recorded every 0.5 seconds using a 24-bit resolution data acquisition system.

19. The process of claim 1, wherein during the preparation of the AC electrode slurry, an intermediate film-drying stage is introduced immediately after doctor blade application but prior to final heat treatment, wherein the wet-coated substrate is placed in a humidity-controlled chamber at 50%±2% relative humidity and 303 K for a period of exactly 25 minutes, and wherein during this period, the surface of the wet film is intermittently scanned using a laser reflectometer every 5 minutes to detect micro-gloss changes that indicate surface skin formation, wherein this partial drying stage is used to initiate controlled solvent evaporation at the top interface while preserving sub-surface wetness, thereby enabling differential densification upon subsequent thermal drying, wherein after this intermediate drying, the film is directly transferred for final curing in a staged temperature profile to preserve the stratified microstructure of the electrode, and wherein the AC-PVA slurry is deposited on the substrate using a dual-pass doctor blade method involving two sequential coatings, wherein the first pass is conducted using a blade gap of 100 microns at a draw speed of 8 mm/s, and the second pass is conducted after a 10-minute delay using a blade gap of 80 microns at a draw speed of 5 mm/s, wherein the delay period between passes is utilized to initiate partial gelation of the base layer, creating a soft-set interface for the second pass, wherein both coatings are applied along perpendicular directions with respect to each other to produce a crisscross grain orientation, and wherein this cross-pattern coating geometry is further stabilized by immediate exposure to a low-speed air stream (0.5 m/s) directed at 45 degrees relative to the substrate surface for 5 minutes to reduce edge sagging and promote uniform lateral diffusion of solvent across both coating layers.
